(19) United States
(12) Patent Application Publication
(10) Pub. No.: US 2025/0306772 A1
(43) Pub. Date: Oct. 2, 2025

(54) COMPUTING SYSTEM AND OPERATING METHOD THEREOF

(71) Applicant: Samsung Electronics Co., Ltd., Suwon-si (KR)

(72) Inventors: Seung Han Lee, Suwon-si (KR); Soo Young Ji, Suwon-si (KR)

(21) Appl. No.: 18/974,331

(22) Filed: Dec. 9, 2024

(30) Foreign Application Priority Data
Mar. 29, 2024 (KR) 10-2024-0043164

(51) Int. Cl. G06F 3/06

(52) U.S. Cl. CPC G06F 3/0619; G06F 3/0653; G06F 3/0683

(57) ABSTRACT

Computing system and operating method thereof are provided. The computing system comprises a storage cluster which includes at least one storage devices, and a switch which is configured to provide an interface between the storage devices included in the storage cluster, in which the storage cluster includes a first storage device and a second storage device, the first storage device includes a first storage controller, a first non-volatile memory which is controlled by the first storage controller, and a first volatile memory which includes a first memory region and a second memory region, in which the first storage device is configured to provide first data stored in the first memory region to the second storage device through the switch, in response to power not being supplied at the first storage device, and the first data is caching data.

### CROSS-REFERENCE TO RELATED APPLICATION

This application claims priority to Korean Patent Application No. 10-2024-0043164 filed in the Korean Intellectual Property Office on Mar. 29, 2024, the contents of which in its entirety are herein incorporated by reference.

### BACKGROUND

A storage device stores data according to the control of a host device such as a computer, a smartphone or a smart pad, and includes, for example, a device for storing data in a semiconductor memory such as a solid state drive (SSD) and a memory card, in particular, a non-volatile memory.

When the storage device is in operation based on power supply, a sudden power off (SPO) situation in which the power is suddenly cut off during operation may occur. In that case, the storage device is desired to move and store the data stored in the volatile memory to another storage space, and if the size of the volatile memory is large, the amount of data being moved and stored also increases. If a battery is the only device used for additional power supply to address the SPO situation, the capacity of the battery limits power supply when moving and storing the data of the volatile memory to another storage space.

### SUMMARY

In general, in some aspects, the present disclosure is directed toward a computing system in which a host and a plurality of storage devices communicate with each other through the same type of interface, when an SPO occurs in any one of the storage devices, data loss may be prevented, by moving some of data stored in a volatility memory inside the storage device to another storage device and storing them therein.

According to some implementations, the present disclosure is directed to a method for operating a computing system in which a host and a plurality of storage devices communicate with each other through the same type of interface, when an SPO occurs in any one of the storage devices, data loss may be prevented, by moving some of data stored in a RAM inside the storage device to another storage device and storing them therein.

According to some implementations, the present disclosure is directed to a computing system comprising a Compute Express Link (CXL) storage cluster which includes at least one CXL storage devices, and a switch which is configured to provide an interface between the CXL storage devices included in the CXL storage cluster, wherein the CXL storage cluster includes a first CXL storage device and a second CXL storage device, the first CXL storage device includes a first CXL storage controller, a first non-volatile memory which is controlled by the first CXL storage controller, and a first volatile memory which includes a first memory region and a second memory region, wherein the first CXL storage device is configured to provide first data stored in the first memory region to the second CXL storage device through the switch, in response to SPO (Sudden Power Off) occurring in the first CXL storage device, and the first data is caching data.

According to some implementations, the present disclosure is directed to a computing system comprising a host, a CXL storage cluster which includes at least one CXL storage device, a CXL memory device which includes a CXL memory controller, and a switch which is configured to provide an interface between the host, the CXL storage device included in the CXL storage cluster, and the CXL memory device, wherein the CXL storage cluster includes a first CXL storage device and a second CXL storage device, the first CXL storage device includes a first CXL storage controller, a first non-volatile memory controlled by the first CXL storage controller, and a first volatile memory which is configured to store first data and second data, wherein the first CXL storage controller is configured to transmit a request corresponding to the first data to the CXL memory controller through the switch, in response to SPO occurring in the first CXL storage device, the CXL memory controller is configured to generate information indicative of transmitting the first data to the second CXL storage device in response to receiving the request, the CXL memory controller is configured to provide the information to the first CXL storage controller through the switch, the first CXL storage controller is configured to provide the first data to the second CXL storage device through the switch in response to receiving the information, and the first data is caching data for the host to access the CXL storage cluster.

According to some implementations, the present disclosure is directed to a method for operating a computing system which includes a host, a CXL storage cluster including a first CXL storage device and a second CXL storage device, a CXL memory device, and a switch, the method comprising transmitting a request to the CXL memory device through the switch, by a first CXL storage controller included in the first CXL storage device, in response to a SPO occurring in the first CXL storage device, receiving the request from the first CXL storage controller through the switch, by a CXL memory controller included in the CXL memory device, generating information indicative of transmitting first data corresponding to at least some of data stored in the first CXL storage device to the second CXL storage device based on the request, by the CXL memory controller, providing the information to the first CXL storage controller through the switch, by the CXL memory controller, and providing the first data to the second CXL storage device through the switch by the first CXL storage controller, in response to receiving the information, wherein the first data is caching data for the host to access the CXL storage cluster.

### BRIEF DESCRIPTION OF THE DRAWINGS

Example implementations will be clearly understood from the following detailed description, taken in conjunction with the accompanying drawings.

FIG. 1 is a diagram showing an example of a computing system according to some implementations.

FIG. 2 is a diagram showing an example of a computing system including a CXL interface according to some implementations.

FIG. 3 is a diagram showing an example of a computing system including a CXL interface according to some implementations.

FIG. 4 is a diagram showing an example of a computing system including heterogeneous storage clusters according to some implementations.

FIG. 5 is a diagram showing an example of a computing system including heterogeneous storage clusters according to some implementations.

FIG. 6 is a diagram showing examples of components of a host and a CXL storage device included in a computing system according to some implementations.

FIG. 7 is a diagram showing examples of a data flushing operation and a data moving operation in a computing system according to some implementations.

FIG. 8 is a diagram showing an example of a computing system according to some implementations.

FIG. 9 is a diagram showing examples of a data flushing operation and data moving operation in a computing system according to some implementations.

FIG. 10 is a diagram showing an example of a computing system including a CXL memory device according to some implementations.

FIG. 11 is a diagram showing an example of a computing system of FIG. 10 according to some implementations.

FIG. 12 is a diagram showing examples of components of a host, a CXL storage device, and a CXL memory device included in a computing system according to some implementations.

FIG. 13 is a diagram showing an example of a data center to which a computing system is applied according to some implementations.

FIG. 14 is a diagram showing an example of a method for operating a computing system according to some implementations.

FIG. 15 is a diagram showing an example of a method for operating a computing system according to some implementations.

FIG. 16 is a diagram showing an example of a computing system according to some implementations.

FIG. 17 is a diagram showing an example of a computing system according to some implementations.

FIG. 18 is a diagram showing an example of a computing system according to some implementations.

FIG. 19 is a diagram showing an example of a computing system according to some implementations.

FIG. 20 is a diagram showing an example of a computing system according to some implementations.

FIG. 21 is a diagram showing an example of a computing system according to some implementations.

FIG. 22 is a flowchart showing an example of an operation of the host 301 of FIG. 21 according to some implementations.

FIG. 23 is a diagram showing an example of an operation of transmitting the data from the virtual machine VM1 to the virtual machine VM2 in the computing system of FIG. 21 according to some implementations.

FIGS. 24 and 25 are flowcharts showing examples of an operation of the computing system of FIG. 21 according to some implementations.

FIGS. 26 to 28 are diagrams showing examples of data transfer of the memory expander of FIG. 21 according to some implementations.

FIG. 29 is a diagram showing an example of a data center in which a computing system is applied according to some implementations.

### DETAILED DESCRIPTION

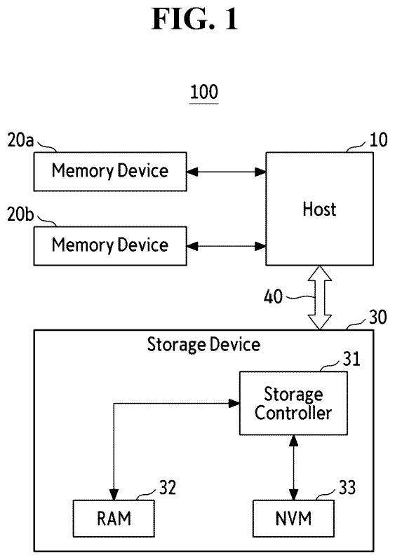

FIG. 1 is a diagram showing an example of a computing system according to some implementations. In FIG. 1, a computing system 100 may include a host 10, a plurality of memory devices 20a and 20b, and a normal storage device 30. The host 10 may control all the operations of the computing system 100. The plurality of memory devices 20a and 20b may be used as working memory or system memory of the host 10.

The normal storage device 30 may include a storage controller 31, a volatile memory 32 (random access memory (RAM)), and a non-volatile memory 33 (NVM). The storage controller 31 may store data in the non-volatile memory 33 or transmit the data stored in the non-volatile memory 33 to the host 10 according to the control of the normal storage device 30.

The volatile memory 32 may be a buffer memory. The volatile memory 32 may store various types of information necessary for the normal storage device 30 to operate. For example, the storage controller 31 may manage data stored in the non-volatile memory 33 by the use of mapping data. The mapping data may be stored in the volatile memory 32. The mapping data may include information about a relationship between a logical block address managed by the host 10 and a physical block address of the non-volatile memory 33. In some implementations, the volatile memory 32 may be a high-speed memory such as a dynamic random access memory (DRAM) or a static random access memory (SRAM).

The host 10 and the storage device 30 may be connected through an interface 40. The interface 40 may be, for example, a host interface such as a PCIe (Peripheral Component Interconnect-Express) or a NVMe (Non-Volatile Memory Express). In this way, whereas the host 10 and the storage controller 31 communicate with each other through the host interface, the volatile memory 32 and the storage controller 31 may communicate with each other through a memory interface such as a DDR (Double Data Rate) or a LPDDR (Low Power DDR) interface.

Accordingly, the storage controller 31 may communicate with the externally located host 10 and the internally included volatile memory 32 through different interfaces (that is, heterogeneous interfaces) from each other.

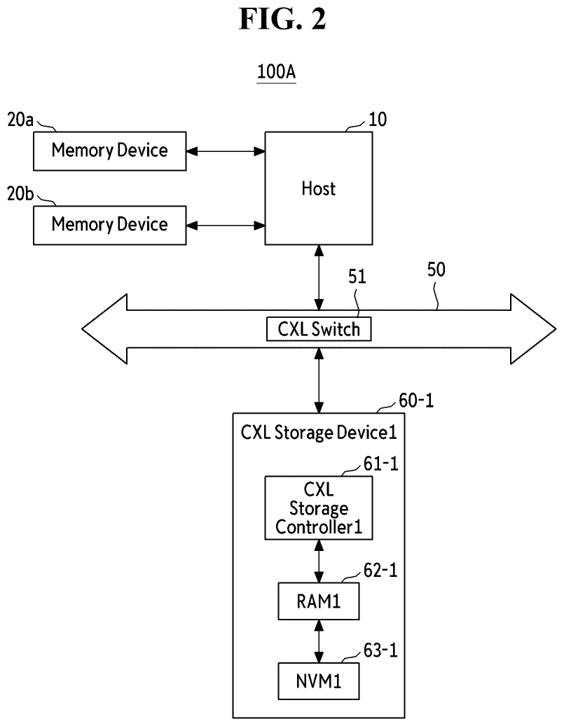

FIG. 2 is a diagram showing an example of a computing system including a CXL interface according to some implementations. In FIG. 2, a computing system 100A may include a host 10, a plurality of memory devices 20a and 20b, a CXL storage device 60-1, a CXL interface 50, and a CXL switch 51.

In some implementations, the computing system 100A may be included in user devices, such as a personal computer, a laptop computer, a server, a media player, and a digital camera, or automotive devices such as a navigation, a black box, and a vehicle electronic device. In some implementations, the computing system 100A may be a mobile system, such as a mobile phone, a smart phone, a tablet pc (tablet personal computer), a wearable device, a healthcare device or an Internet of things (IoT) device.

The host 10 may control all the operations of the computing system 100A. In some implementations, the host 10 may be one of various processors, such as a CPU (central processing unit), a GPU (graphics processing unit), an NPU (neural processing unit), and a DPU (data processing unit). In some implementations, the host 10 may each include a single-core processor or a multi-core processor.

The plurality of memory devices 20a and 20b may be used as a main memory or a system memory of the computing system 100A. The memory devices 20a and 20b may be connected to the host 10. In some implementations, each of the plurality of memory devices 20a and 20b may be a dynamic random access memory (DRAM) device, and may have a form factor of a dual in-line memory module (DIMM). However, the present disclosure is not limited thereto, and the plurality of memory devices 20a and 20b may include a non-volatile memory such as a flash memory, a PRAM (phase change RAM), a RRAM (resistive ram), and a MRAM (magnetic ram).

The memory devices 20a and 20b may communicate directly with the host 10 through a DDR interface. In some implementations, the host 10 may each include controllers configured to control each of the plurality of memory devices 20a and 20b. However, the present disclosure is not limited thereto, and each of the plurality of memory devices 20a and 20b may communicate with each of the host 10 through various interfaces.

The CXL storage device 60-1 may include a CXL storage controller 61-1, a volatile memory 62-1, and a non-volatile memory 63-1. The CXL storage controller 61-1 may store data in a non-volatile memory 63-1 or transmit the data stored in the non-volatile memory 63-1 to the host 10 according to the control of the host 10. In some implementations, the non-volatile memory 63-1 may be, but not limited to, a NAND flash memory.

The volatile memory 62-1 may be a buffer memory. The volatile memory 62-1 may store various types of information necessary for the CXL storage device 60-1 to operate. For example, the CXL storage controller 61-1 may manage data stored in the non-volatile memory 63-1 by using mapping data. The mapping data may be stored in the volatile memory 62-1. The mapping data may include information about a relationship between the logical block addresses managed by the host 10 and the physical block addresses of the non-volatile memory 63-1. In some embodiments, the volatile memory 62-1 may be a high-speed memory such as a DRAM or a SRAM.

In some implementations, the host 10 and the CXL storage device 60-1 may communicate with each other through the CXL interface 50 (compute express link interface). Specifically, the host 10 and the CXL storage device 60-1 may communicate through a CXL switch 51 included in the CXL interface 50. In some implementations, the CXL interface 50 may mean a low-latency and high-bandwidth link that supports coherency, memory access, and dynamic protocol muxing of dynamic protocol of input/output protocol (IO protocol) to enable various connections between accelerators, memory devices or various electronic devices.

Hereinafter, for convenience of explanation, it is assumed that the host 10 and the CXL storage device 60-1 communicate with each other through the CXL interface 50. However, the present disclosure is not limited thereto, and the host 10 and the CXL storage device 60-1 may communicate with each other based on various computing interfaces such as a GEN-Z protocol, a NVLink protocol, a CCIX protocol, and an Open CAPI protocol.

Unlike the computing system 100 of FIG. 1 in which the storage controller 31 communicates with the host 10 externally located and the volatile memory 32 included internally through different interfaces from each other, in the computing system 100A, the CXL storage controller 61-1 may communicate with the host 10 and the volatile memory 62-1 through the CXL interface 50. That is, the CXL storage controller 61-1 of the CXL storage device 60-1 may communicate with the host 10 and the volatile memory 62-1 through homogeneous interface or a common interface.

Hereinafter, repeated explanations of those of the previous implementations will not be provided, and the explanation will focus on the differences.

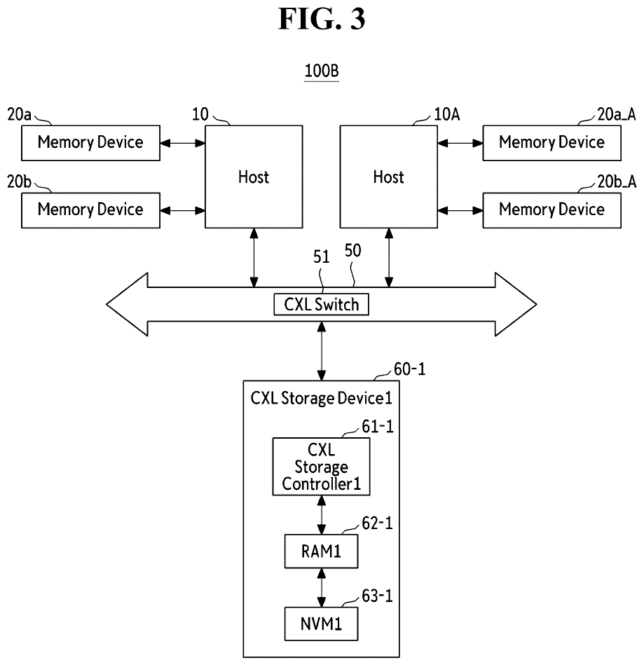

FIG. 3 is a diagram showing an example of a computing system including a CXL interface according to some implementations. In FIG. 3, a computing system 100B may further include a host 10A and a plurality of memory devices 20a_A and 20b_A. The plurality of memory devices 20a_A and 20b_A may be used as a main memory or a system memory of the computing system 100B. The memory devices 20a_A and 20b_A may be connected to the host 10A. In some implementations, each of the plurality of memory devices 20a_A and 20b_A may be a DRAM device, and may have a form factor of a dual in-line memory module (DIMM). However, the present disclosure is not limited thereto, and the plurality of memory devices 20a_A and 20b_A may include a non-volatile memory such as a flash memory, a PRAM (phase change ram), a RRAM (resistive ram), and a MRAM (magnetic ram).

The memory devices 20a_A and 20b_A may communicate directly with the host 10_A through a DDR interface. In some implementations, the host 10A may include controllers configured to control each of the plurality of memory devices 20a_A and 20b_A. However, the present disclosure is not limited thereto, and the plurality of memory devices 20a_A and 20b_A may communicate with the host 10A through various interfaces.

The host 10A may communicate with the CXL storage device 60-1 through the CXL interface 50. Specifically, the host 10A and the CXL storage device 60-1 may communicate through the CXL switch 51. The CXL storage controller 61-1 may communicate with the host 10A and the volatile memory 62-1 through a homogeneous interface or a common interface (e.g., the CXL interface 50).

In this way, the computing system 100B may include a plurality of hosts 10 and 10A that each communicate with the CXL storage device 60-1 through the CXL switch 51. Although FIG. 3 shows that the computing system 100B includes two hosts 10 and 10A, according to the embodiment, the number of hosts that communicate with the CXL storage device 60-1 through the CXL switch 51 may be more than that.

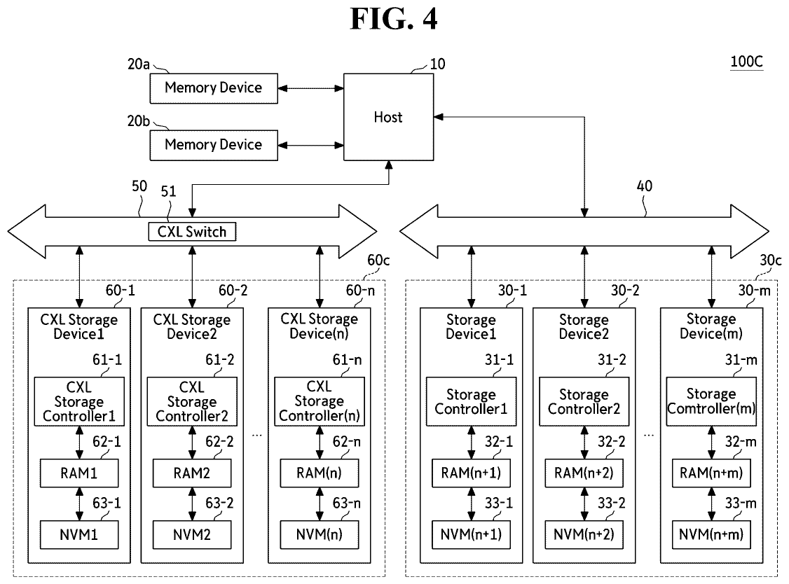

FIG. 4 is a diagram showing an example of a computing system including heterogeneous storage clusters according to some implementations. In FIG. 4, the computing system 100C may include a host 10, a plurality of memory devices 20a and 20b, a CXL storage cluster 60C, a normal storage cluster 30C, a CXL interface 50, a CXL switch 51, and an interface 40.

The CXL storage cluster 60C may include a plurality of CXL storage devices 60-1 to 60-n (n is an integer of 2 or more). The CXL storage device 60-2 may include a CXL storage controller 61-2, a volatile memory 62-2, and a non-volatile memory 63-2. Similarly, the CXL storage device 60-n may include a CXL storage controller 61-n, a volatile memory 62-n, and a non-volatile memory 63-n. In this way, because the CXL storage devices 60-2 to 60-n include a configuration similar to that of the CXL storage device 60-1, explanation of configurations of the CXL storage devices 60-2 to 60-n will not be provided.

The normal storage cluster 30C may include a plurality of normal storage devices 30-1 to 30-m (m is an integer of 2 or more). The normal storage device 30-2 may include a storage controller 31-2, a volatile memory 32-2, and a non-volatile memory 33-2. Similarly, the normal storage device 30-m may include a storage controller 31-m, a volatile memory 32-m, and a non-volatile memory 33-m. In this way, because the normal storage devices 30-2 to 30-m include a configuration similar to that of the normal storage device 30-1, explanation of the configuration of the normal storage devices 30-2 to 30-m will not be provided.

The host 10 and the CXL storage devices 60-1 to 60-n included in the CXL storage cluster 60C may be configured to share the same interface. For example, the host 10 and the CXL storage devices 60-1 to 60-n may communicate with each other through the CXL switch 51 included in the CXL interface 50.

The host 10 and the normal storage devices 30-1 to 30-m included in the normal storage cluster 30C may be configured to share the same interface. For example, the host 10 and the normal storage devices 30-1 to 30-m may communicate with each other through an interface such as a PCI-E and a NVMe.

In this way, the computing system 100C may be a heterogeneous server system including a plurality of normal storage devices 30-1 to 30-m and a plurality of CXL storage devices 60-1 to 60-n. In the heterogeneous server system, the host 10 may communicate with the CXL storage cluster 60C and the normal storage cluster 30C through different interfaces from each other.

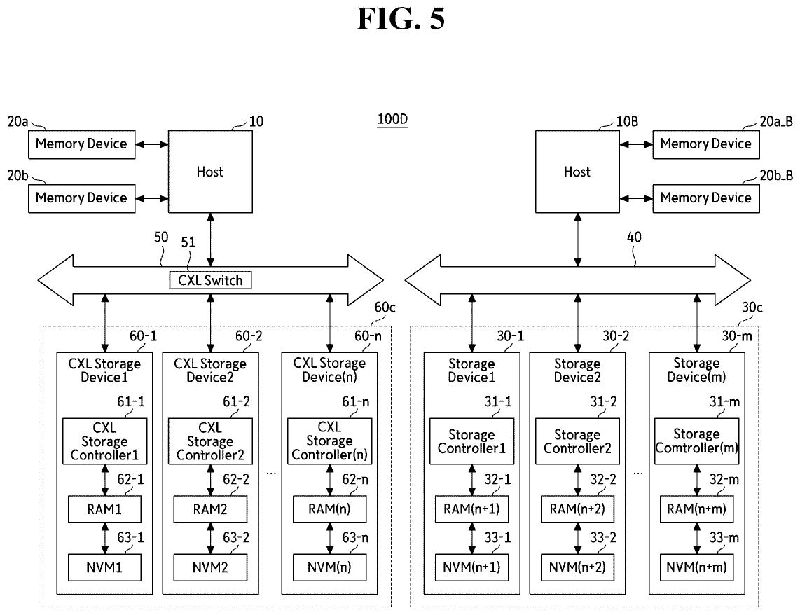

FIG. 5 is a diagram showing an example of a computing system including heterogeneous storage clusters according to some implementations. In FIG. 5, a computing system 100D may further include a host 10B and a plurality of memory devices 20a_B and 20b_B. The plurality of memory devices 20a_B and 20b_B may be used as a main memory or a system memory of the computing system 100D. The memory devices 20a_B and 20b_B may be connected to the host 10B. In some implementations, each of the plurality of memory devices 20a_B and 20b_B may be a DRAM device, and may have a form factor of a dual in-line memory module (DIMM). However, the present disclosure is not limited thereto, and the plurality of memory devices 20a_B and 20b_B may include a non-volatile memory such as a flash memory, a PRAM (phase change ram), a RRAM (resistive ram), and a MRAM (magnetic ram).

The memory devices 20a_B and 20b_B may communicate directly with the host 10B through a DDR interface. In some implementations, the host 10B may include controllers configured to control each of the plurality of memory devices 20a_B and 20b_B. However, the present disclosure not limited thereto, and the plurality of memory devices 20a_B and 20b_B may communicate with the host 10B through various interfaces.

The host 10B may communicate with the normal storage devices 30-1 to 30-m of the normal storage cluster 30C through the interface 40. In this way, in the computing system 100D implemented as a heterogeneous server system including the plurality of normal storage devices 30-1 to 30-m and the plurality of CXL storage devices 60-1 to 60-n, the CXL storage devices 60-1 to 60-n and the normal storage devices 30-1 to 30-m may each communicate with each of the different hosts 10 and 10B through the different interfaces from each other.

Although FIG. 5 shows one host that communicates with the CXL storage cluster 60C through the CXL interface 50, the present disclosure is not limited thereto. According to some implementations, the number of hosts that communicate with the CXL storage devices 60-1 to 60-n through the CXL interface 50 may be two or more. Similarly, the number of hosts communicating with the normal storage devices 30-1 to 30-m through the interface 40 may be two or more.

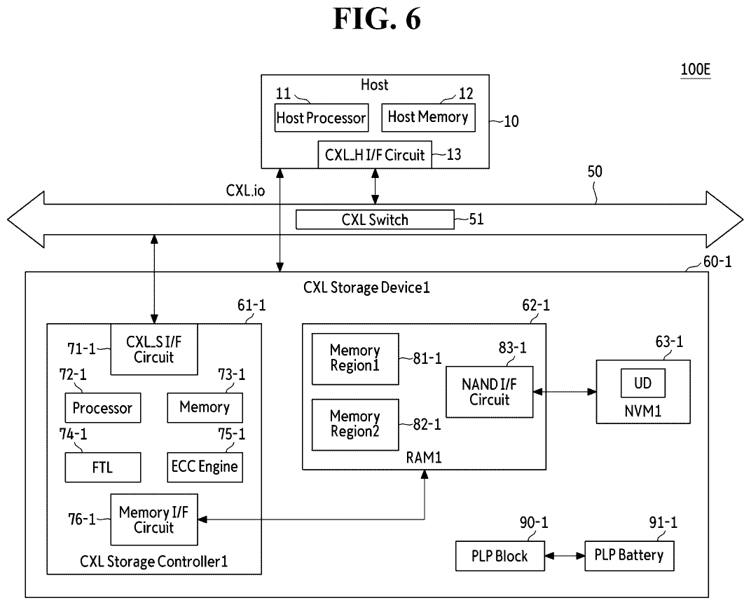

FIG. 6 is a diagram showing examples of components of a host and a CXL storage device included in the computing system according to some implementations. In particular, FIG. 6 shows examples of the components of the host 10 and the CXL storage device 60-1 of FIG. 2.

A computing system 100E may include a host 10, a CXL storage device 60-1, a CXL interface 50, and a CXL switch 51. Although FIG. 6 only shows the host 10 and the CXL storage device 60-1, as described above, when the computing system 100E includes the plurality of hosts and the plurality of CXL storage devices, the following explanation of the host 10 and the CXL storage device 60-1 may be equally applicable to other hosts and other CXL storage devices included in the computing system 100E.

In FIG. 6, the CXL interface 50 may include a lower protocol CXL.io. The CXL.io protocol is a PCIe transaction layer, and may be used in the computing system 100E for device search, interrupt management, access provision by register, initialization processing, signal error processing, and the like. In addition, the CXL interface 50 may include CXL.cache protocol, and CXL.mem protocol. The CXL.cache protocol may be used when an accelerator (e.g., GPU or FPGA (Field Programmable Gate Array)) accesses the host memory 12. The CXL.mem protocol may be used when the host 10 accesses dedicated memory of the accelerator or the volatile memory 62-1 of the CXL storage device 60-1.

In some implementations, the host 10 and the CXL storage device 60-1 may communicate with each other, using CXL.io which is an I/O protocol. The CXL.io may have a PCIe-based inconsistent I/O protocol. The host 10 and the CXL storage device 60-1 may send and receive various types of information including the user data UD, using the user CXL.io.

The host 10 may include a host processor 11, a host memory 12, and a CXL host interface circuit 13. The host processor 11 may generally control the operation of the host 10. In some implementations, the host processor 11 may be one of the plurality of modules provided in the application processor (AP), and the application processor may be implemented as a system-on-chip (SOC).

The host memory 12 is a working memory, and may store commands, programs, data, and the like required for the operation of the host processor 11. In some implementations, the host memory 12 may function as a buffer memory for temporarily storing the data to be transmitted to or the data transmitted from the CXL storage device 60-1. If the host processor 11 is implemented as an AP, the host memory 12 may be an embedded memory provided within the AP, or may be a non-volatile memory or a memory module placed outside the AP.

According to some implementations, the host processor 11 and the host memory 12 may be implemented as separate semiconductor chips. In some implementations, the host processor 11 and the host memory 12 may be integrated on the same semiconductor chip.

The CXL host interface circuit 13 may communicate with the CXL storage device 60-1 through the CXL interface 50. Specifically, the CXL host interface circuit 13 may communicate with the CXL storage device 60-1 through a CXL switch 51 included in the CXL interface 50.

In some implementations, the CXL storage device 60-1 may include a CXL storage controller 61-1, a volatile memory 62-1, a non-volatile memory 63-1, a Power Loss Protection (PLP) block (circuit) 90-1, and a PLP storage device (battery) 91-1.

The CXL storage controller 61-1 may include a CXL storage interface circuit 71-1, a processor 72-1, a memory 73-1, a flash translation layer (FTL) 74-1, an error correction code (ECC) engine 75-1, and a memory interface circuit 76-1.

The CXL storage interface circuit 71-1 may be connected to the CXL switch 51. The CXL storage interface circuit 71-1 may communicate with the host 101 or other CXL storage devices included in the computing system 100E through the CXL switch 51.

The processor 72-1 may be configured to control the general operation of the CXL storage controller 61-1. The memory 73-1 may be used as a working memory or a buffer memory of the CXL storage controller 61-1.

The FTL 74-1 may perform various management operations for using the non-volatile memory 63-1 efficiently. For example, the FTL 74-1 may perform an address conversion between a logical block address managed by the host 10 and a physical block address used in the non-volatile memory 63-1, based on the mapping data or the mapping table. At this time, the mapping data and the mapping table used when performing the address translation by the FTL 74-1 may be stored in the volatile memory 62-1.

The FTL 74-1 may perform a bad block management operation on the non-volatile memory 63-1. The FTL 74-1 may perform a wear leveling operation on the non-volatile memory 63-1. Furthermore, the FTL 74-1 may perform a garbage collection operation on the non-volatile memory 63-1.

In some implementations, the FTL 74-1 may be implemented based on software, hardware, firmware or a combination thereof. When the FTL 74-1 is implemented in the form of software or firmware, the program codes associated with the FTL 74-1 may be stored in the memory 73-1 and may be run by the processor 72-1. If the FTL 74-1 is implemented as hardware, hardware configurations configured to perform the various management operations described above may be implemented in the CXL storage controller 61-1.

The ECC engine 75-1 may perform error detection and correction functions on the data stored the non-volatile memory 63-1. For example, the ECC engine 75-1 may generate parity bits for the user data UD to be stored in the non-volatile memory 63-1, and the parity bits thus generated may be stored in the non-volatile memory 63-1 together with the user data UD. When the user data UD is read from the non-volatile memory 63-1, the ECC engine 75-1 may detect and correct an error of the user data UD, using the parity bits that are read from the non-volatile memory 63-1, together with the read user data UD.

The memory interface circuit 76-1 may control the volatile memory 62-1 so that data is stored in the volatile memory 62-1 or data is read from the volatile memory 62-1. In some implementations, the memory interface circuit 76-1 may be implemented to comply with standard protocol such as a DDR interface, and a LPDDR interface.

The volatile memory 62-1 may store data or output the stored data according to the control of the CXL storage controller 61-1. The volatile memory 62-1 may be a high-speed memory such as a DRAM or a SRAM. The volatile memory 62-1 in the CXL storage device 60-1 may store the mapping data and the mapping table as shown in the volatile memory 32 (shown in FIG. 1) in the normal storage device 30 (shown in FIG. 1), and may function as a buffer memory.

The volatile memory 62-1 may store or output the mapping data according to the control of the CXL storage controller 61-1. In some implementations, the mapping data stored in the volatile memory 62-1 may include mapping information corresponding to the entire user data UD stored in the non-volatile memory 63-1.

In some implementations, the volatile memory 62-1 inside the CXL storage device 60-1 performs such FTL mapping and data buffering functions, and may simultaneously function as a memory expander of the host 10. Accordingly, the volatile memory 62-1 in the CXL storage device 60-1 may perform the caching function of the host 10. That is, by caching a large capacity of data stored in the non-volatile memory 63-1 or to be stored in the non-volatile memory 63-1 by the request of the host 10 to the volatile memory 62-1, a low-latency approach may be provided to the host 10. In the following explanation, data cached in the volatile memory 62-1 is defined as caching data.

In some implementations, the volatile memory 62-1 may store various types of information necessary for the CXL storage device 60-1 to operate. For example, the volatile memory 62-1 may include memory regions 81-1 and 82-1. Different types of data may be stored in the memory regions 81-1 and 82-1. For example, mapping data may be stored in the memory region 81-1, and the caching data may be stored in the memory region 82-1.

The volatile memory 62-1 may include a NAND interface circuit 83-1. The NAND interface circuit 83-1 may control the non-volatile memory 63-1 so that data is stored in the non-volatile memory 63-1 or data is read from the non-volatile memory 63-1. In some implementations, the NAND interface circuit 83-1 may be implemented to comply with standard protocol such as a toggle interface or ONFI.

For example, if the non-volatile memory 63-1 includes a plurality of NAND flash devices and the NAND interface circuit 83-1 is implemented based on a toggle interface, the NAND interface circuit 83-1 may communicate with the plurality of NAND flash devices through a plurality of channels, and the plurality of NAND flash devices may be connected to the plurality of channels through a multichannel-multiway structure.

In some implementations, the NAND interface circuit 83-1 may transmit a chip enable signal/CE, a command latch enable signal CLE, an address latch enable signal ALE, a read enable signal/RE, and a write enable signal/WE to each of a plurality of NAND flash devices through each of a plurality of channels. In addition, the NAND interface circuit 83-1 and each of the plurality of NAND flash devices may send and receive the data signal DQ and the data strobe signal DQS through each of the plurality of channels.

Although the NAND interface circuit 83-1 is shown in FIG. 6 as being included in the volatile memory 62-1, the present disclosure is not limited thereto. For example, if the volatile memory 62-1 is included in the CXL storage controller 61-1, the NAND interface circuit 83-1 may be placed inside the CXL storage controller 61-1 and outside the volatile memory 62-1.

The non-volatile memory 63-1 may store or output the user data UD according to the control of the CXL storage controller 61-1.

A PLP block 90-1 may be configured to prevent a loss of power when an abnormal sudden power-off (SPO) occurs in the CXL storage device 60-1. The PLP block 90-1 is connected to a PLP battery 91-1, and may perform an operation of monitoring the power of the CXL storage device 60-1 and supplying the power to the CXL storage device 60-1 to prevent data loss when an SPO is detected.

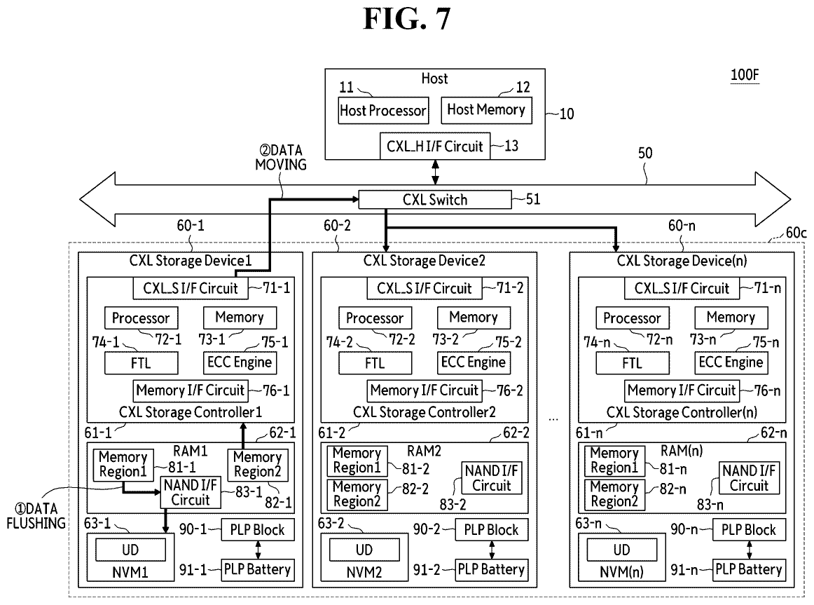

FIG. 7 is a diagram showing examples of a data flushing operation and a data moving operation in a computing system according to some implementations. In FIG. 7, a computing system 100F may include a host 10, a CXL storage cluster 60C, a CXL interface 50, and a CXL switch 51. Because the CXL storage devices 60-2 to 60-n included in the CXL storage cluster 60C include a structure similar to that of the CXL storage device 60-1, a description of the configuration of the CXL storage devices 60-2 to 60-n will not be provided.

Hereinafter, a case where an SPO occurs in the CXL storage device 60-1 among the plurality of CXL storage devices 60-1 to 60-n included in the CXL storage cluster 60C will be described as an example.

In some implementations, when the PLP block 90-1 detects that an SPO occurs in the CXL storage device 60-1, the PLP block 90-1 may perform data flushing (\textcircled{1} data flushing) for dumping only the mapping data stored in the memory region 81-1 of the volatile memory 62-1 to the non-volatile memory 63-1. In this way, data stored in the volatile memory 62-1 when an SPO occurs in the CXL storage device 60-1 need to be retained. At this time, among the data stored in the volatile memory 62-1, data to be used inside the CXL storage device 60-1 (e.g., mapping data) may be dumped to the non-volatile memory 63-1.

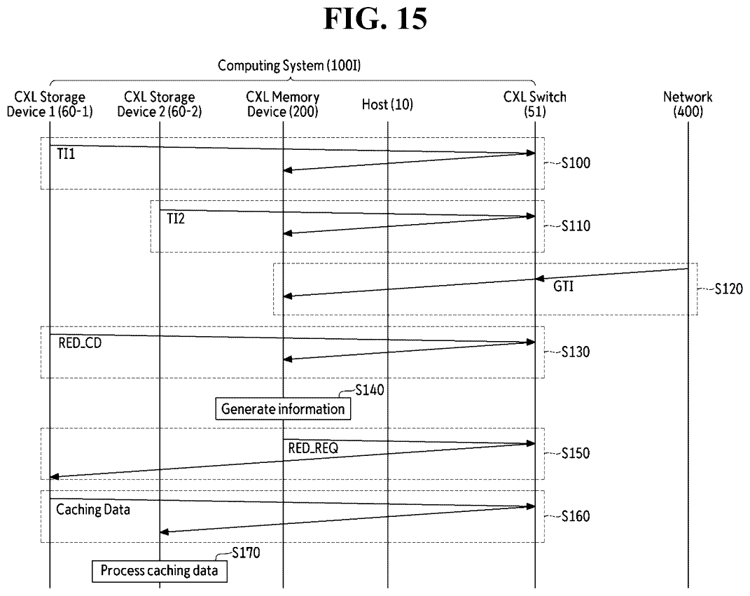

At this time, only the limited capacity of the PLP battery 91-1 may not be sufficient to maintain all the data stored in the volatile memory 62-1. Accordingly, among the data stored in the volatile memory 62-1, data used inside the CXL storage device 60-1 (e.g., mapping data) may be flushed to the non-volatile memory 63-1 by the use of the PLP battery 91-1. Among the data stored in the volatile memory 62-1, the caching data that needs to be accessed by the host 10 may be moved to other CXL storages devices 60-2 to 60-n included in the CXL storage cluster 60C by the use of the CXL interface 50 (\textcircled{2} data moving). A method for moving the caching data stored in the memory region 82-1 of the volatile memory 62-1 of the CXL storage device 60-1 to other CXL storage devices 60-2 to 60-n by the use of the CXL switch 51 will be described later with reference to FIG. 15 or the like.

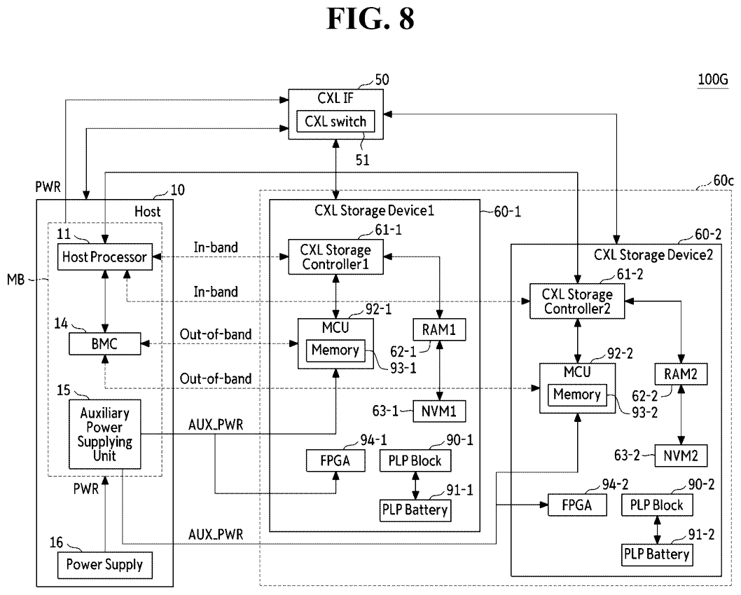

FIG. 8 is a diagram showing an example of a computing system according to some implementations. Hereinafter, in order to simplify the drawings, the CXL storage cluster 60C is shown to include only the CXL storage device 60-1 and the CXL storage device 60-2. However, as shown in FIG. 7 or the like, it goes without saying that the CXL storage cluster 60C includes three or more CXL storage devices.

In FIG. 8, in a computing system 100G, the host 10 may further include a power supply 16, a baseboard management controller (BMC) 14, and an auxiliary power supplying unit 15. The host processor 11, the BMC 14, and the auxiliary power supplying unit 15 may be included in a main board MB. Further, each of the CXL storage device 60-1 and the CXL storage device 60-2 may further include micro controller units (MCU) 92-1 and 92-2, and FPGAs 94-1 and 94-2.

The power supply 16 may generate power PWR from a power source, and supply the generated power PWR to the main board MB. In some implementations, the power supply 16 may directly supply the power to the CXL interface 50. The power supply 16 may be a main power supply of the computing system 100G. That is, in a normal state in which no SPO occurs in either of the CXL storage devices 60-1 and 60-2, the CXL storage cluster 60C may receive supply of the power PWR generated by the power supply 16 to operate.

The main board MB is also called a mother board or a base board, and may include a host processor 11, a BMC 14, and an auxiliary power supplying unit 15. The host processor 11 may access the CXL interface 50 to control power operation for the CXL storage cluster 60C. For example, the host processor 11 may perform load balancing power, or may perform an operation of supplying the power to the CXL storage cluster 60C through the CXL interface 50, and monitoring the power.

The BMC 14 may be configured to manage internal components of the CXL storage cluster 60C including the CXL storage devices 60-1 and 60-2. In some implementations, the BMC 14 programs the plurality of CXL storage devices 60-1 and 60-2 inside the CXL storage cluster 60C according to instructions provided by the administrator of the computing system 100G, and may set the plurality of CXL storage devices 60-1 and 60-2 and the CXL interface 50 to establish boot and control paths. The BMC 14 may monitor the physical status of the server corresponding to the host 10 using sensors. For example, the BMC 14 may check hardware health information and power consumption information such as a connection status, a lifespan, a temperature, and log information of the CXL storage devices 60-1 and 60-2.

The auxiliary power supplying unit 15 may supply power to the MCUs 92-1 and 92-2. The MCUs 92-1 and 92-2 are each supplied with voltage from the auxiliary power supplying unit 15 and may operate independently of the CXL storage devices 60-1 and 60-2, respectively. The auxiliary power supplying unit 15 may be an auxiliary power supply of the computing system 100G, unlike the power supply 16 that is the main power supply of the computing system 100G.

That is, in a special situation in which the CXL storage devices 60-1 and 60-2 included in the CXL storage cluster 60C are not supplied with the power PWR from the power supply 16, the auxiliary power supplying unit 15 may supply the CXL storage devices 60-1 and 60-2 with the auxiliary power AUX_PWR.

For example, even if the power source of the CXL storage devices 60-1 and 60-2 is turned off, the MCUs 92-1 and 92-2 may be supplied with power from the auxiliary power supplying unit 15 to still operate. Further, even in a situation in which a SPO occurs in the CXL storage devices 60-1 and 60-2 and power is not supplied, the MCUs 92-1 and 92-2 may be supplied with power from the auxiliary power supplying unit 15 to continue the operations. The MCUs 92-1 and 92-2 may include memories 93-1 and 93-2, respectively. The memories 93-1 and 93-2 may each be a DRAM, a SRAM, a FRAM, etc.

The MCUs 92-1 and 92-2 may communicate independently of the BMC 14. That is, the MCUs 92-1 and 92-2 may send and receive signals independently of the BMC 14 without the control of the host processor 11. A route by which the host processor 11 sends and receives signals to and from the CXL storage controllers 61-1 and 61-2 may be called in-band. In contrast, a route by which the BMC 14 sends and receives signals to and from the MCUs 92-1 and 92-2 may be called out-of-band.

In some implementations, when the host processor 11 and the CXL storage controllers 61-1 and 61-2 send and receive signals on an in-band route, they may communicate with each other through the CXL interface 50, and when the BMC 14 and the MCUs 92-1 and 92-2 send and receive signals on an out-of-band route, they may not communicate with each other through the CXL interface 50. However, the present disclosure is not limited thereto, and both in-band routes and out-of-band route may be connected through the CXL interface 50.

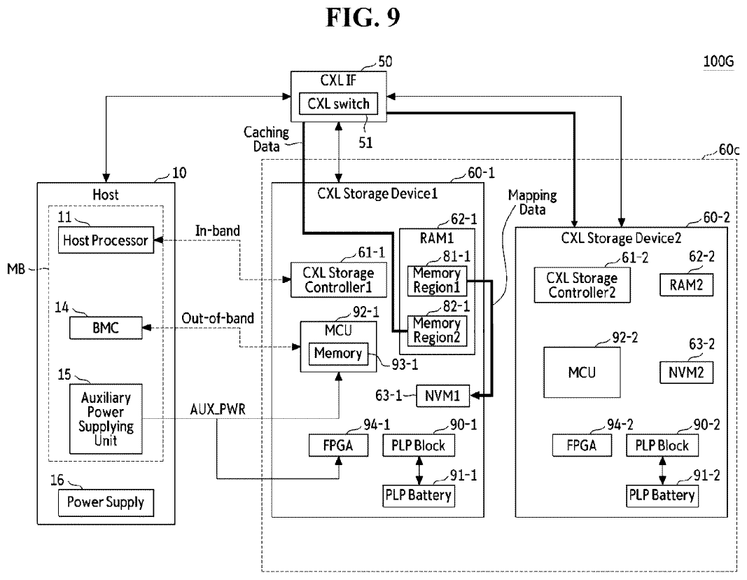

FIG. 9 is a diagram showing examples of a data flushing operation and data moving operation in a computing system according to some implementations. Hereinafter, a case where an SPO occurs in the CXL storage device 60-1 and some of the data stored in the CXL storage device 60-1 are moved to the CXL storage device 60-2 will be described as an example.

When the power supply 16 is unable to supply the power PWR to the CXL storage cluster 60C, an SPO may occur in the CXL storage device 60-1. At this time, the BMC 14 may communicate independently with the MCU 92-1 through the out-of-band route, and the auxiliary power supplying unit 15 may supply the auxiliary power AUX_PWR to the MCU 92-1 and/or FPGA 94-1. When the auxiliary power AUX_PWR is supplied to the MCU 92-1 and/or the FPGA 94-1, the CXL storage controller 61-1 may move the caching data stored in the memory region 82-1 of the volatile memory 62-1 to the CXL storage device 60-2 through the CXL switch 51 included in the CXL interface 50. At this time, the CXL storage controller 61-1 may move the caching data to the CXL storage device 60-2 through the CXL switch 51 using the in-band route.

At this time, the operation in which the CXL storage controller 61-1 moves the caching data to the CXL storage device 60-2 through the CXL switch 51 may be based on the fact that the MCU 92-1 switches the auxiliary power AUX_PWR supplied from the auxiliary power supplying unit 15, and transfers it to the CXL storage controller 61-1.

On the other hand, when the SPO is detected while monitoring the power of the CXL storage device 60-1, the PLP block 90-1 may dump the mapping data stored in the memory region 81-1 of the volatile memory 62-1 to the non-volatile memory 63-1.

In this way, when a SPO occurs in any one device among the plurality of CXL storage devices included in the CXL storage cluster 60C, among the plurality of data stored in the volatile memory inside the device, the mapping data required to be used inside that device may be moved to and stored in the non-volatile memory inside that device, and the caching data that needs to be accessed by the host 10 may be moved to and stored in another CXL storage device through the CXL switch. This makes it possible to prevent an occurrence of data loss when an SPO occurs in the CXL storage device.

Hereinafter, a method for moving the caching data stored in the volatile memory inside that device to another CXL storage device through the CXL switch when an SPO occurs in any one device among the plurality of CXL storage devices included in the CXL storage cluster will be explained.

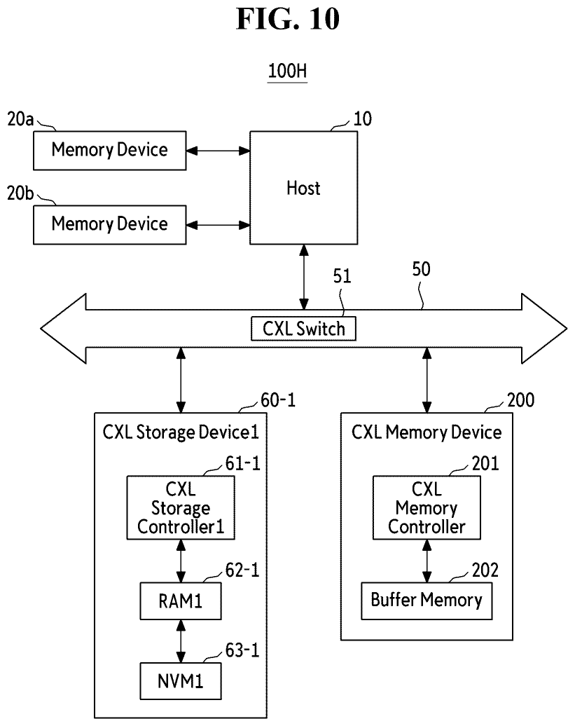

FIG. 10 is a diagram showing an example of a computing system including a CXL memory device according to some implementations. In FIG. 10, a computing system 100H may include a host 10, a plurality of memory devices 20a and 20b, a CXL storage device 60-1, a CXL memory device 200, a CXL interface 50, and a CXL switch 51.

The CXL memory device 200 may include a CXL memory controller 201 and a buffer memory 202. The CXL memory controller 201 may store data in the buffer memory 202 according to the control of the host 10, or may transmit the data stored in the buffer memory 202 to the host 10. The buffer memory 202 may be a DRAM or a SRAM, but embodiments are not limited thereto.

In some implementations, the host 10, the CXL storage device 60-1, and the CXL memory device 200 may be configured to share the same interface with each other. For example, the host 10, the CXL storage device 60-1, and the CXL memory device 200 may communicate with each other through the CXL interface 50 and the CXL switch 51 included therein.

In some implementations, at least a partial region of the CXL memory device 200 may be used as a buffer memory of the CXL storage device 60-1. In this case, at least a partial region of the CXL memory device 200 may be allocated by the host 10 into a buffer memory of the CXL storage device 60-1 (that is, a dedicated region of the CXL storage device 60-1). Accordingly, some of the data stored in the volatile memory 62-1 of the CXL storage device 60-1 may be stored in the CXL memory device 200.

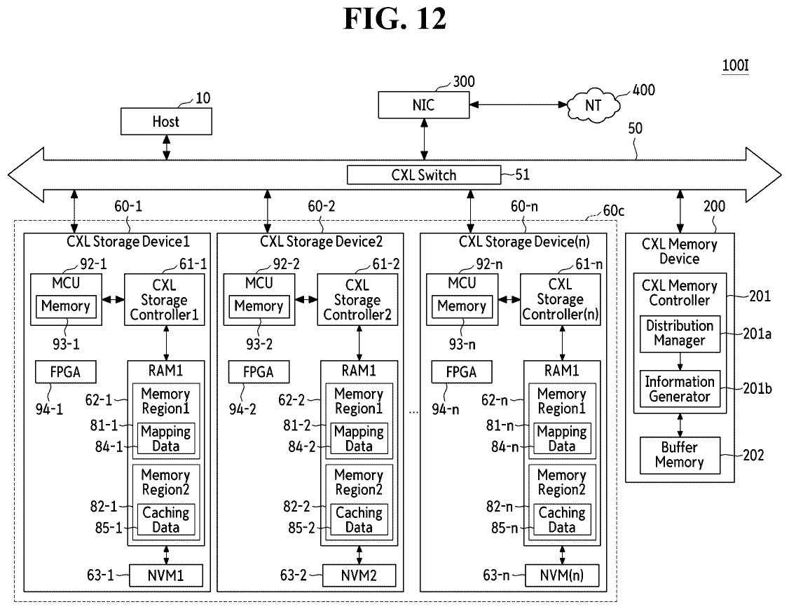

The CXL storage device 60-1 may access the CXL memory device 200 through the CXL interface 50. The CXL memory device 200 may store data in the buffer memory 202 or transmit the data stored in the buffer memory 202 to the CXL storage device 60-1 according to the control of the CXL storage controller 61-1. The detailed configuration of the CXL memory device 200 will be described later with reference to FIG. 12.

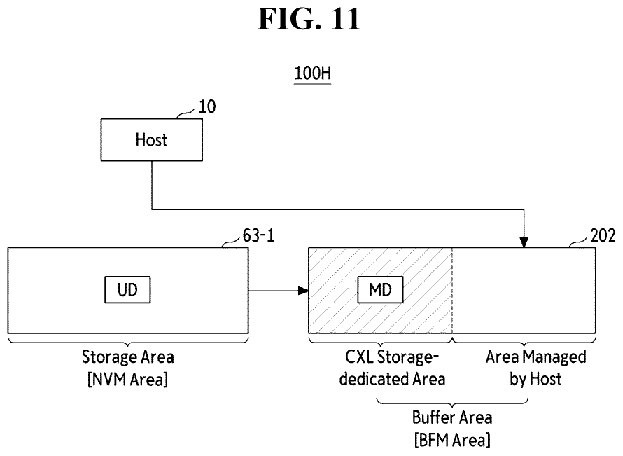

FIG. 11 is a diagram showing an example of a computing system of FIG. 10 according to some implementations. In FIG. 11, the host 10 may allocate a partial region of the CXL memory device 200 as a dedicated region for the CXL storage device 60-1. In this case, the dedicated region of the CXL memory device 200 may be accessed by the CXL storage device 60-1, and may be used to store meta data MD associated with the user data UD stored in the non-volatile memory 63-1 of the CXL storage device 60-1.

For example, the non-volatile memory 63-1 of the CXL storage device 60-1 may store the user data UD. The volatile memory 62-1 of the CXL storage device 60-1 may store the meta data MD associated with the user data UD. As the capacity of the non-volatile memory 63-1 increases, size of the required meta data MD may be increased. However, since the capacity of the volatile memory 62-1 included in a single CXL storage device 60-1 is limited, in order to cope with the increase in size of the meta data MD due to the increase in the capacity of the non-volatile memory 63-1, at least a partial region of the buffer memory 202 of the CXL memory device 200 may be allocated to a dedicated region of the CXL storage device 60-1.

In some implementations, among the regions of the CXL memory device 200, the remaining region that is not allocated to a dedicated region may be a region that is accessible by the host 10 or managed by the host 10. In this case, the host 10 may access the remaining region among the regions of the CXL memory device 200 through the CXL switch 51. In some implementations, the remaining region of CXL memory device 200 that is not allocated to a dedicated region may be used as a memory expander.

As explained above, the host 10 may allocate at least partial region of the CXL memory device 200 as a dedicated region to the CXL storage device 60-1 in response to a request from the CXL storage device 60-1. In this case, the CXL storage device 60-1 may access the allocated dedicated region among the regions of the CXL memory device 200, and the host 10 may access the remaining region among the regions of the CXL memory device 200 (i.e., the remaining regions except the allocated dedicated region). In some implementations, both access of the CXL storage device 60-1 and access of the host 10 to the CXL memory device 200 may be performed through the same interface (e.g., the CXL interface 50 or the CXL switch 51).

FIG. 12 is a diagram showing examples of components of a host, a CXL storage device, and a CXL memory device included in a computing system according to some implementations. In FIG. 12, a computing system 100I may include a host 10, a network interface controller 300, a CXL interface 50, a CXL switch 51, a plurality of CXL storage devices 60-1 to 60-n, and a CXL memory device 200.

The host 10, the network interface controller 300, the plurality of CXL storage devices 60-1 to 60-n, and the CXL memory device 200 may be connected to the CXL switch 51, and each of them may communicate with each other through the CXL switch 51. That is, the CXL switch 51 may provide an interface between the host 10, the network interface controller 300, the plurality of CXL storage devices 60-1 to 60-n, and the CXL memory device 200.

In some implementations, the host 10 may support a Hadoop distributed file system (HDFS). The host 10 may use the CXL memory device 200 as a name node of HDFS, and may use the plurality of CXL storage devices 60-1 to 60-n as data nodes of HDFS. For example, the CXL memory device 200 may be a master node of HDFS, and the plurality of CXL storage devices 60-1 to 60-n may be slave nodes of HDFS.

The network interface controller 300 may communicate with other computing systems other than the computing system 100I through the network 400. The network 400 may be realized using FC (Fibre Channel), Ethernet, or the like. The plurality of CXL storage devices 60-1 to 60-n may be called a CXL storage cluster 60C managed by the host 10.

In some implementations, each of the plurality of CXL storage devices 60-1 to 60-n may store the mapping data. Further, the plurality of CXL storage devices 60-1 to 60-n may store the caching data in a distributed manner. For example, the volatile memory 62-1 of the CXL storage device 60-1 may include a memory region 81-1 and a memory region 82-1, the mapping data 84-1 may be stored in the memory region 81-1, and the caching data 85-1 may be stored in the memory region 82-1.

Similarly, the volatile memory 62-2 of the CXL storage device 60-2 may include a memory region 81-2 and a memory region 82-2, the mapping data 84-2 may be stored in the memory region 81-2, and the caching data 85-2 may be stored in the memory region 82-2. Similarly, the volatile memory 62-n of the CXL storage device 60-n may include a memory region 81-n and a memory region 82-n, the mapping data 84-n may be stored in the memory region 81-n, and the caching data 85-n may be stored in the memory region 82-n.

At this time, the mapping data 84-1 to 84-n stored inside each of the volatile memories 62-1 to 62-n may be data required to convert a logical block address into a physical block address inside each of the CXL storage devices 60-1 to 60-n. Furthermore, the caching data 85-1 to 85-n stored inside each of the volatile memories 62-1 to 62-n may be data required for the host 10 to access the CXL storage cluster 60C with low delay.

According to some implementations, the caching data 85-1 to 85-n may be stored in a distributed manner in another CXL storage device of another computing system that communicates with the computing system 100I through the network 400.

The CXL memory device 200 may include a CXL memory controller 201 and a buffer memory 202. The CXL memory controller 201 may communicate with a plurality of CXL storage devices 60-1 to 60-n through the CXL switch 51. The CXL memory controller 201 may be connected to the network 400 through the CXL switch 51 and the network interface controller 300, and may communicate with another CXL memory controller of another CXL memory device of another computing system through the network 400.

The buffer memory 202 may communicate with the CXL memory controller 201. At least a partial region of the buffer memory 202 may be a region allocated to the buffer memories of the CXL storage devices 60-1 to 60-n. Accordingly, some of the data stored in each of the volatile memories 62-1 to 62-n of the CXL storage devices 60-1 to 60-n may be stored in the buffer memory 202.

The CXL memory controller 201 may perform load balancing and distributed file management of the caching data 85-1 to 85-n stored in the distributed manner in the plurality of CXL storage devices 60-1 to 60-n. The load balancing may be a selection of the CXL storage device that is suitable for storing the caching data among the plurality of CXL storage devices to retain the caching data when an SPO occurs on an existing CXL storage device that stores the caching data. The distributed file management may be a management of access to the caching data that is stored in the distributed manner in the computing system 100I and another computing system that communicate with each other through the network 400.

The CXL memory controller 201 of the CXL memory device 200 may include a distribution manager 201a and an information generator 201b. The distribution manager 201a and the information generator 201b may be implemented as a high performance circuit, a device, a module, and the like. As yet another example, some of the distribution manager 201a and the information generator 201b may be implemented as software and some others thereof may be implemented as hardware. However, the present disclosure is not necessarily limited thereto.

Hereinafter, a case where an SPO occurs in the CXL storage device 60-1 will be described as an example.

The distribution manager 201a may periodically update telemetry information from the plurality of CXL storage devices 60-1 to 60-n through the CXL switch 51. The distribution manager 201a may receive request for processing of the caching data from the CXL storage controller 61-1. The distribution manager 201a may select the CXL storage device suitable for processing the request from the CXL storage device 60-1 among the plurality of CXL storage devices 60-1 to 60-n, by analyzing the updated telemetry information.

The telemetry information may include, for each of the plurality of CXL storage devices 60-1 to 60-n, at least one of an execution status indicating whether the corresponding CXL storage device is performing an arbitrary operation such as reading or writing, a remaining capacity of the non-volatile memories 63-1 to 63-n of the corresponding CXL storage device, an I/O bandwidth indicating input/output data per unit time of the corresponding CXL storage device, a usage amount of the processor inside the corresponding CXL storage device, and a usage amount of the data buffer of the corresponding CXL storage device.

In some implementations, the distribution manager 201a may manage the global telemetry information. The global telemetry information may include telemetry information received from another distribution manager of another CXL memory device of another computing system communicating through the network 400, and network bandwidth of another computing system. The distribution manager 201a may periodically update the global telemetry information from another computing system through the network 400. The distribution manager 201a may determine whether the computing system 100I is suitable for processing the request of the CXL storage controller 61-1 based on request from the CXL storage controller 61-1, telemetry information, and global telemetry information.

When the computing system 100I is determined to be suitable for processing the request of the CXL storage controller 61-1, the distribution manager 201a may select a CXL storage device suitable for processing the request from the CXL storage controller 61-1 among the plurality of CXL storage devices 60-2 to 60-n.

When the computing system 100I is determined not to be suitable for processing the request of the CXL storage controller 61-1, the distribution manager 201a may redirect the request of the CXL storage controller 61-1 to another distribution manager of other CXL memory of another computing system through the network 400.

The information generator 201b may generate alternative CXL storage device information according to the control of the distribution manager 201a. The alternative CXL storage device information may include information about a CXL storage device suitable for storing the caching data 85-1 stored in the volatile memory 62-1 of the CXL storage device 60-1 in which a SPO occurs among the plurality of CXL storage devices 60-2 to 60-n, in placed of the CXL storage device 60-1.

For example, the CXL storage controller 61-1 may provide the CXL memory device 200 with a request corresponding to the caching data 85-1. The distribution manager 201a may determine that the CXL storage device 60-2 is suitable to process the request of the CXL storage controller 61-1. In this case, the information generator 201b may generate alternative CXL storage device information about the CXL storage device 60-2.

The information generator 201b included in the CXL memory controller 201 may provide the CXL storage controller 61-1 with a redirection request including the alternative CXL storage device information. The CXL storage controller 61-1 may provide the caching data 85-1 to the CXL storage device 60-2 through the CXL switch 51 according to the alternative CXL storage device information, in response to the redirection request.

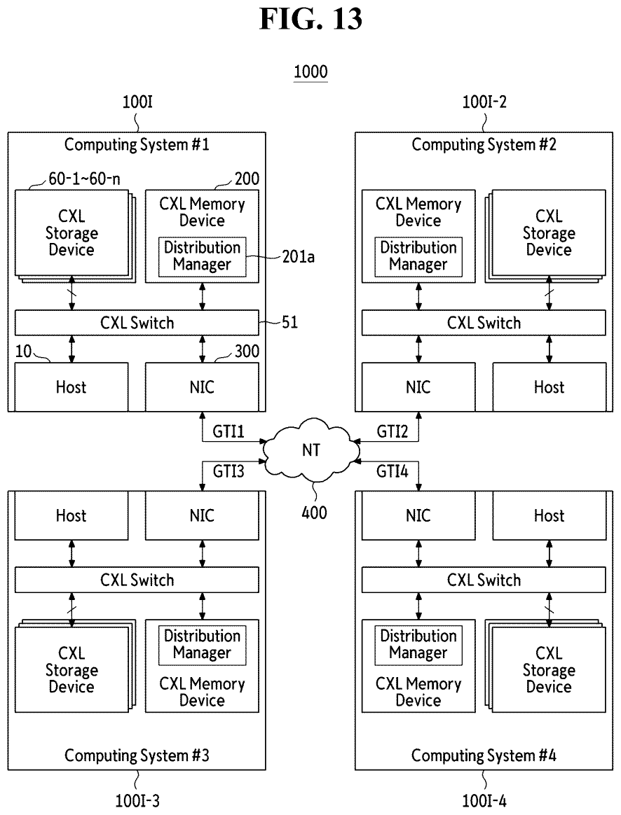

FIG. 13 is a diagram showing an example of a data center to which a computing system is applied according to some implementations. In FIG. 13, a data center 1000 may include computing systems 100I, 100I-2, 100I-3, and 100I-4 and a network 400.

The computing system 100I may include a host 10, a network interface controller 300, a plurality of CXL storage devices 60-1 to 60-n, a CXL memory device 200, and a CXL switch 51. The CXL memory device 200 may include a distribution manager 201a and an information generator 201b. The distribution manager 201a may manage telemetry information within the computing system 100I and global telemetry information GTI1, GTI2, GTI3, and GTI4 from the external computing systems 100I-2, 100I-3, and 100I-4. Each of the computing systems 100I-2, 100I-3, and 100I-4 may have a structure similar to the computing system 100I.

In some implementations, the plurality of computing systems 100I, 100I-2, 100I-3, and 100I-4 may exchange the global telemetry information GTI1, GTI2, GTI3, and GIT4, by communicating with each other through the network 400.

The global telemetry information may include telemetry information and network bandwidth at the corresponding computing system. For example, the global telemetry information GTI1 may include telemetry information corresponding to the CXL storage devices of the computing system 100I and the network bandwidth dependent on the network interface controller 300 of the computing system 100I. Similarly, each of the global telemetry information GTI2, GTI3, and GTI4 may include telemetry information and network bandwidth of the computing systems 100I-2, 100I-3, and 100I-4. The global telemetry information may be used in determining whether each of the plurality of computing systems 100I, 100I-2, 100I-3, and 100I-4 autonomously processes the caching data stored in the CXL storage device in which an SPO occurs, or provides a redirection request to another computing system.

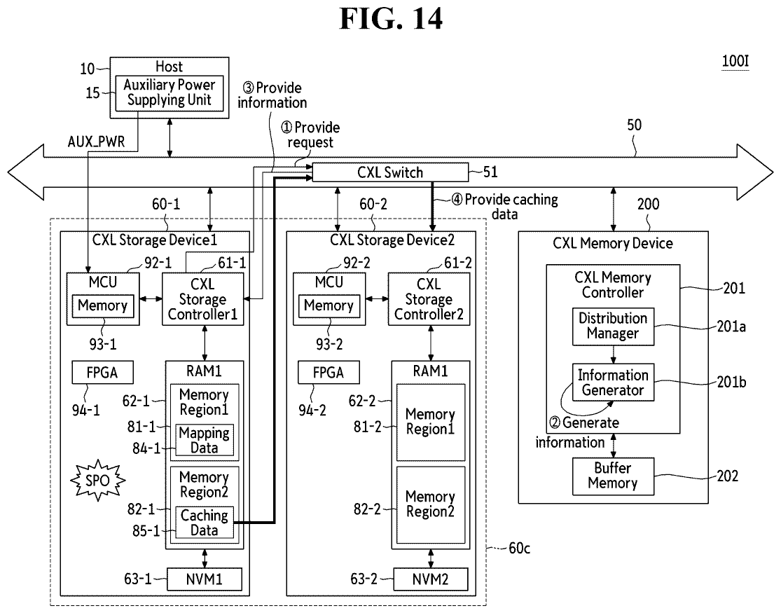

FIG. 14 is a diagram showing an example of a method for operating a computing system according to some implementations. Hereinafter, a case where an SPO occurs in the CXL storage device 60-1, and the caching data 85-1 stored in the volatile memory 62-1 of the CXL storage device 60-1 is moved to the CXL storage device 60-2 will be explained as an example.

In FIGS. 12 and 14, the computing system 100I may include a host 10, a CXL switch 51, a plurality of CXL storage devices 60-1 to 60-n, and a CXL memory device 200.

Hereinafter, an example of a method for operating the computing system 100I according to some implementations will be explained.

In a first operation \textcircled{1}, the CXL storage controller 61-1 may provide a request corresponding to the caching data 85-1 to the CXL memory device 200 through the CXL switch 51. The request may be a request for information about another CXL storage device that stores the caching data 85-1 in placed of the CXL storage device 60-1, among the CXL storage devices included in the CXL storage cluster 60C.

In a second operation \textcircled{2}, the CXL memory device 200 may generate alternative CXL storage device information, by analyzing the telemetry information of the plurality of CXL storage devices 60-1 to 60-n based on the request of the first operation \textcircled{1}. The alternative CXL storage device information may include information about the CXL storage device that is suitable for storing the caching data 85-1 stored in the volatile memory 62-1 of the CXL storage device 60-1 in which an SPO occurs among the CXL storage devices 60-1 to 60-n, in placed of the CXL storage device 60-1.

In a third operation \textcircled{3}, the CXL memory controller 201 may provide the alternative CXL storage device information of the second operation \textcircled{2} to the CXL storage controller 61-1 through the CXL switch 51.

In some implementations, the CXL memory controller 201 may provide the alternative CXL storage device information to the CXL storage device 60-1 through the CXL switch 51, by the use of CXL.mem of the CXL interface 50.

In a fourth operation \textcircled{4}, the CXL storage controller 61-1 may provide the caching data 85-1 to the CXL storage device 60-2 according to the alternative CXL storage device information based on the alternative information provision of the third operation \textcircled{3}. At this time, the CXL storage controller 61-1 may provide the caching data 85-1 to the CXL storage device 60-2 through the CXL switch 51, by the use of CXL.mem of the CXL interface 50.

FIG. 15 is a diagram showing an example of a method for operating a computing system according to some implementations. In FIGS. 12 to 15, the computing system 100I may be connected to the network 400. The computing system 100I may communicate with at least one additional computing systems 100I-2, 100I-3, and 100I-4 through the network 400. The computing system 100I may include the CXL storage devices 60-1 to 60-n, the CXL memory device 200, the host 10, and the CXL switch 51. The CXL storage devices 60-1 to 60-n may store the caching data in a distributed manner.

At step S100, the CXL storage device 60-1 may periodically provide telemetry information TI1 to the CXL memory device 200 through the CXL switch 51. The CXL memory device 200 may periodically update the telemetry information TI1.

At step S110, the CXL storage device 60-2 may periodically provide the telemetry information TI2 to the CXL memory device 200 through the CXL switch 51. The CXL memory device 200 may periodically update the telemetry information TI2.

At step S120, at least one additional computing systems 100I-2, 100I-3, and 100I-4 may periodically provide at least one global telemetry information GTI to the CXL memory device 200 through the network 400 and the CXL switch 51. The CXL memory device 200 may periodically update at least one global telemetry information GTI. In some embodiments, step S120 may be omitted when the computing system 100I is implemented as a single server device.

At step S130, the CXL storage device 60-1 may provide the CXL memory device 200 with a request REQ_CD corresponding to the caching data 85-1 through the CXL switch 51. For example, the request REQ_CD may be a request for information about another CXL storage device that stores the caching data 85-1 in placed of the CXL storage device 60-1, among the CXL storage devices 60-2 to 60-n included in the CXL storage cluster 60C.

At step S140, the CXL memory device 200 may generate information about the selected CXL storage device 60-2 inside the storage cluster 60C, by analyzing the telemetry information TI and at least one global telemetry information GTI based on the request REQ_CD.

For example, the CXL memory device 200 may determine whether the computing system 100I and at least one additional computing systems 100I-2, 100I-3, and 100I-4 connected to the computing system 100I through the network 400 are suitable for processing the request REQ_CD, based on the request REQ_CD, the telemetry information TI, and at least one global telemetry information GTI. The CXL memory device 200 may select a computing system to process the request REQ_CD. After selecting the computing system, the CXL memory device 200 may select the CXL storage device 60-2 suitable for storing the caching data 85-1 in the CXL storage cluster 60C, by analyzing the telemetry information TI based on the request REQ_CD. The CXL memory device 200 may generate information about the selected CXL storage device 60-2 (i.e., alternative CXL storage device information).

At step S150, the CXL memory device 200 may provide a redirection request RED_REQ including the alternative CXL storage device information to the CXL storage device 60-1 through the CXL switch 51.

At step S160, the CXL storage device 60-1 may communicate with the selected CXL storage device 60-2 of the CXL storage cluster 60C through the CXL switch 51 based on the redirection request RED_REQ, thereby processing the caching data 85-1. Step S160 may include an operation of providing the caching data 85-1 stored in the memory region 82-1 of the volatile memory 62-1 to the CXL storage device 60-2 based on the redirection request RED_REQ by the CXL storage device 60-1.

At step S170, the CXL storage device 60-2 may receive the caching data 85-1 through the CXL switch 51, and process the received caching data 85-1. Step S170 includes an operation of storing the caching data 85-1 received by the CXL storage controller 61-2 in the memory region 82-2 of the volatile memory 62-2 or an operation of storing the caching data 85-1 in the non-volatile memory 63-2.

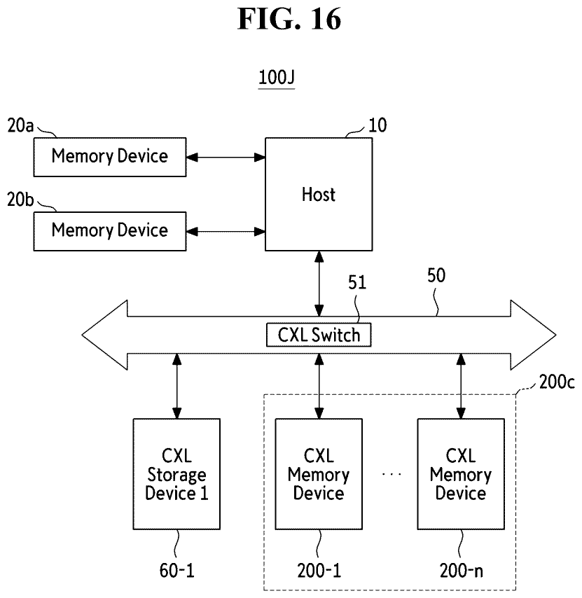

FIG. 16 is a diagram showing an example of a computing system according to some implementations. In FIG. 16, a computing system 100J may include a host 10, a plurality of memory devices 20a and 20b, a CXL switch 51, a CXL storage device 60-1, and a plurality of CXL memory devices 200-1 to 200-n.

The host 10 may be directly connected to the plurality of memory devices 20a and 20b. The host 10, the CXL storage device 60-1, and the plurality of CXL memory devices 200-1 to 200-n may be connected to the CXL switch 51, and each of them may communicate with each other through the CXL switch 51.

In some implementations, each of the plurality of CXL memory devices 200-1 to 200-n may have a similar structure to the CXL memory device 200 explained with reference to FIGS. 10 to 15. That is, each of the plurality of CXL memory devices 200-1 to 200-n may be implemented as an individual memory device or memory module, and may be connected to the CXL switch 51 through different physical ports from each other. That is, by connecting the plurality of CXL memory devices 200-1 to 200-n to the CXL switch 51, the capacity of the memory region managed by the host 10 may increase.

In some implementations, the host 10 may manage the plurality of CXL memory devices 200-1 to 200-n as one memory cluster 200C. In some implementations, the host 10 may allocate at least some of the plurality of CXL memory devices 200-1 to 200-n as the dedicated memory for the CXL storage device 60-1. In some implementations, the host 10 may allocate at least some of each of the plurality of CXL memory devices 200-1 to 200-n as the dedicated memory for the CXL storage device 60-1.

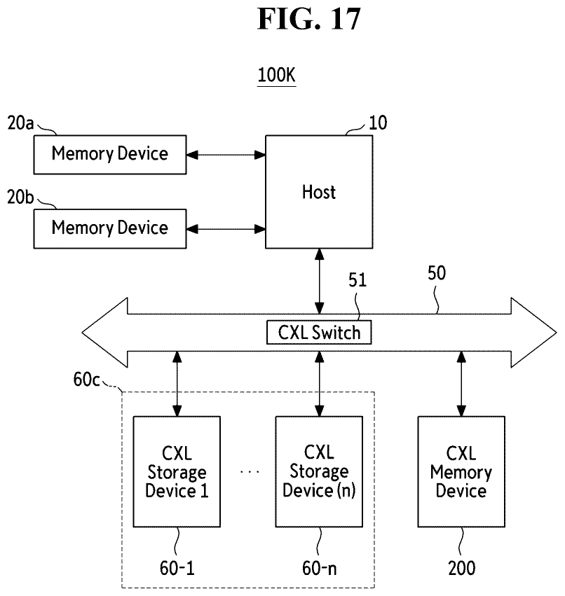

FIG. 17 is a diagram showing an example of a computing system according to some implementations. In FIG. 17, a computing system 100K may include a host 10, a plurality of memory devices 20a and 20b, a CXL switch 51, a plurality of CXL storage devices 60-1 to 60-n, and a CXL memory device 200.

The host 10 may be directly connected to the plurality of memory devices 20a and 20b. The host 10, the plurality of CXL storage devices 60-1 to 60-n, and the CXL memory device 200 may be connected to the CXL switch 51, and each of them may communicate with each other through the CXL switch 51.

In some implementations, each of the plurality of CXL storage devices 60-1 to 60-n may be implemented as individual storage devices or storage modules, and may be connected to the CXL switch 51 through different physical ports from each other. That is, by connecting a plurality of CXL storage devices 60-1 to 60-n to the CXL switch 51, the capacity of the storage region usable by the host 10 may increase.

In some implementations, at least a partial region of the CXL memory device 200 may be allocated as a dedicated region for the plurality of CXL storage devices 60-1 to 60-n. For example, the host 10 may manage the plurality of CXL storage devices 60-1 to 60-n as one CXL storage cluster 60C, and may allocate the partial region of the CXL memory devices 200 as a dedicated region for one CXL storage cluster 60C. In some implementations, the host 10 may allocate partial regions of the CXL memory device 200 as the dedicated region for each of the plurality of CXL storage devices 60-1 to 60-n.

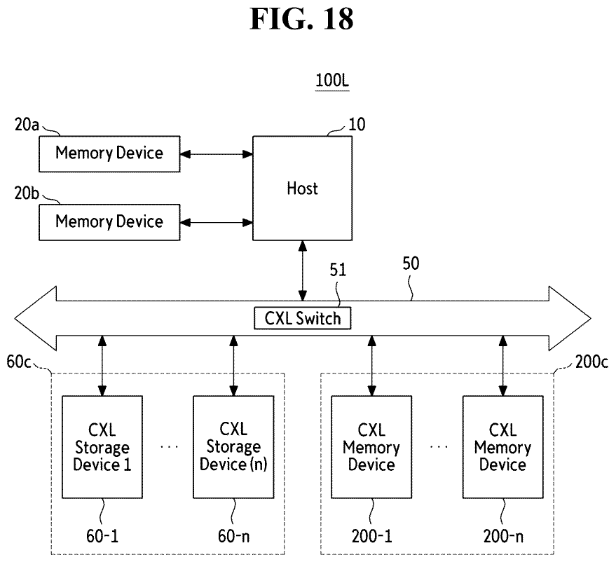

FIG. 18 is a diagram showing an example of a computing system according to some implementations. In FIG. 18, a computing system 100L may include a host 10, a plurality of memory devices 20a and 20b, a CXL switch 51, a plurality of CXL storage devices 60-1 to 60-n, and a plurality of CXL memory devices 200-1 to 200-n.

The host 10 may be directly connected to the plurality of memory devices 20a and 20b. The host 10, the plurality of CXL storage devices 60-1 to 60-n, and the plurality of CXL memory devices 200-1 to 200-n may be connected to the CXL switch 51, and each of them may communicate with each other.

In some implementations, the host 10 may manage the plurality of CXL storage devices 60-1 to 60-n as one CXL storage cluster 60C, and manage the plurality of CXL memory devices 200-1 to 200-n as one memory cluster 200C. The host 10 may allocate a partial region of the memory cluster 200C as a dedicated region (that is, a region for storing meta data of the CXL storage cluster 60C) to one CXL storage cluster 60C. In some implementations, the host 10 may allocate regions of the plurality of CXL [symbol] memory devices 200-1 to 200-n as the dedicated regions to the plurality of CXL storage devices 60-1 to 60-n, respectively.

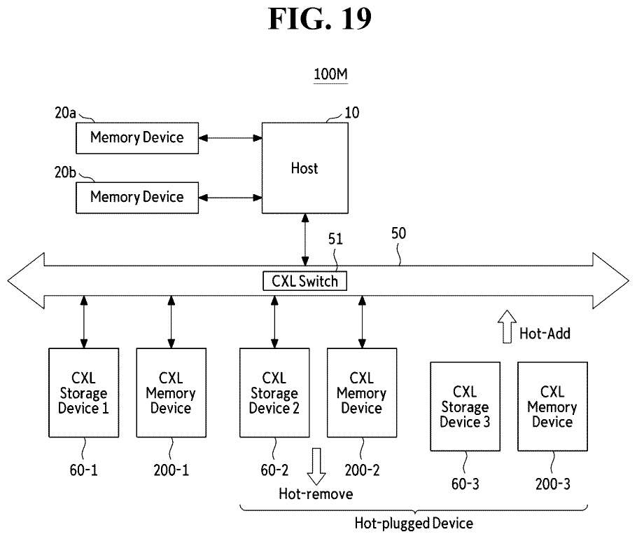

FIG. 19 is a diagram showing an example of a computing system according to some implementations. In FIG. 19, a computing system 100M may include a host 10, a plurality of memory devices 20a and 20b, a CXL switch 51, a plurality of CXL storage devices 60-1, 60-2, and 60-3, and a plurality of CXL memory devices 200-1, 200-2, and 200-3.

The host 10 may be directly connected to the plurality of memory devices 20a and 20b. The host 10, the plurality of CXL storage devices 60-1, 60-2, and 60-3, and the plurality of CXL memory devices 200-1, 200-2, and 200-3 may be connected to the CXL switch 51, and each of them may communicate with each other through the CXL switch 51. In the similar manner, partial regions of the CXL memory devices 200-1, 200-2, and 200-3 may be dedicated regions for the CXL storage devices 60-1, 60-2, and 60-3.

In some implementations, while the computing system 100M is being run, some of the CXL storage devices 60-1 and 60-2 or some of the CXL memory devices 200-1 and 200-2 may be disconnected or hot-removed from the CXL switch 51. In some implementations, while the computing system 100M is being run, some CXL storage device 60-3 or some CXL memory device 200-3 may be connected or hot-added to the CXL switch 51. In this case, the host 10 may re-perform the memory allocation, by re-performing the initialization operation on the devices connected to the CXL switch 51 through a reset operation or a hot-plug operation. That is, the CXL storage device and the CXL memory device according to some embodiments may support hot-plug function, and may expand the storage capacity and memory capacity of the computing system through various connections.

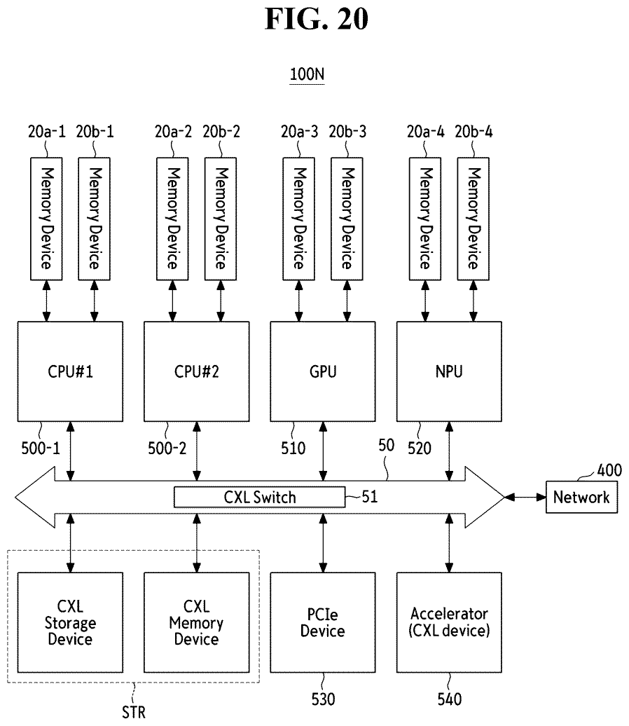

FIG. 20 is a diagram showing an example of a computing system according to some implementations. In FIG. 20, a computing system 100N may include a first CPU 500-1, a second CPU 500-2, a GPU 510, an NPU 520, a CXL switch 51, a CXL storage device 60-1, a CXL memory device 200, a PCIe device 530, and an accelerator (CXL device) 540.

The first CPU 500-1, the second CPU 500-2, the GPU 510, the NPU 520, the CXL storage device 60-1, the CXL memory device 200, the PCIe device 530, and the accelerator (CXL device) 540 may be commonly connected to the CXL switch 51, and each of them may communicate with each other through the CXL switch 51.

In some implementations, each of the first CPU 500-1, the second CPU 500-2, the GPU 510, and the NPU 520 may be hosts explained with reference to FIGS. 1 to 19. Each of them may be directly connected to individual memory devices 20a-1 to 20a-4 and 20b-1 to 20b-4.

In some implementations, the CXL storage device 60-1 and the CXL memory device 200 may be the CXL storage device and CXL memory device explained with reference to FIGS. 2 to 19. At least a partial region of the CXL memory device 200 may be allocated as a dedicated region for the CXL storage device 60-1, by any one or more of the first CPU 500-1, the second CPU 500-2, the GPU 510, and the NPU 520. That is, the CXL storage device 60-1 and the CXL memory device 200 may be used as a storage space STR of the computing system 100N.

In some implementations, the CXL switch 51 may be connected to the PCIe device 530 or the accelerator 540 configured to support various functions, and the PCIe device 530 or the accelerator 540 may communicate with each of the first CPU 500-1, the second CPU 500-2, the GPU 510, and the NPU 520 through the CXL switch 51, or may access the storage space STR including the CXL storage device 60-1 and the CXL memory device 200.

In some implementations, the CXL switch 51 may be connected to an external network 400 or fabric, and may be configured to communicate with an external server through the external network 400 or fabric.

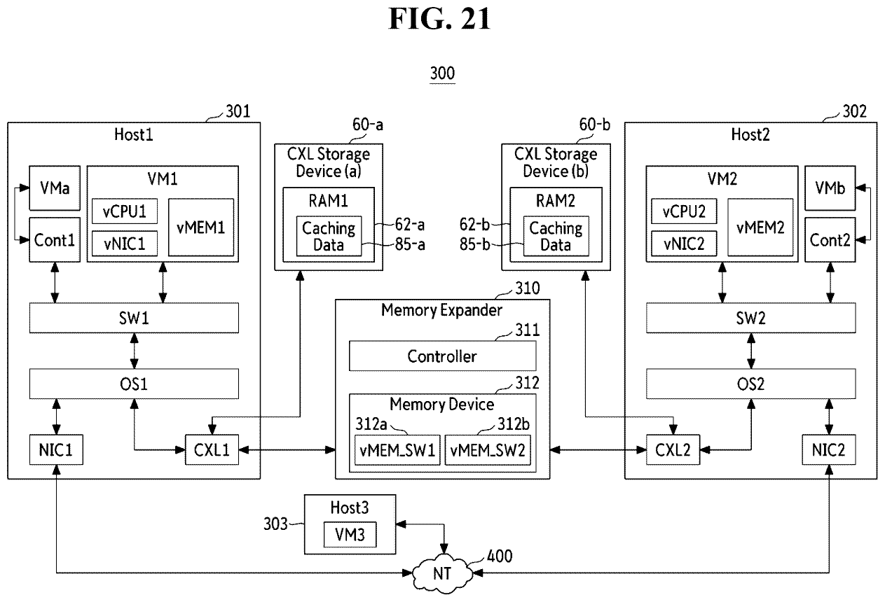

FIG. 21 is a diagram showing an example of a computing system according to some implementations. In FIG. 21, a computing system 300 may include a host 301, a host 302, the CXL storage devices 60-a and 60-b, and a memory expander 310. In some implementations, the computing system 300 may be a system that stores/manages various types of data, such as a data center, or provides services to clients.

Hereinafter, in order to easily explain the technical idea of the present disclosure, some implementations will be described based on a virtualized system. Although the components shown in the drawings may be virtualized components, the scope of the present disclosure is not limited thereto. For example, a virtual machine VM1 of the host 301 may be a virtual machine that is implemented using some or all of the physical resources included in the host 301 (e.g., a physical processor, a physical memory, a physical peripheral device, etc.). That is, a virtual CPU vCPU1 may be a virtualized component that processes computations based on all or part of the physical processor included in the host 301, and a virtual memory vMEM1 may be a virtualized component configured to store/output data based on all or part of the physical memory included in the host 301. The various virtualized components may share the same physical resources, or one physical resource may be distributed or allocated to each of the virtualized components.

The host 301 may include an operating system OS1, the plurality of virtual machines VM1 and VMa, a container Cont1, a switch SW1, a network interface controller NIC1, and a heterogeneous computing interface controller CXL1. The operating system OS1 may be run on the host 301, and may control or manage the general operation of the host 301.

The plurality of virtual machines VM1 and VMa may be virtual systems that are run on the operating system OS1. Each of the plurality of virtual machines VM1 and VMa may drive an independent or individual operating system. For example, the virtual machine VM1 may include a virtual central processing unit vCPU1, a virtual memory vMEM1, and a virtual network interface controller vNIC1.

The virtual central processing unit vCPU1 may be configured to execute various computations run in the virtual machine VM1. The virtual memory vMEM1 may be configured to store data used or generated by the virtual machine VM1. The virtual network interface controller vNIC1 may be configured to control a communication between the virtual machine VM1 and the external components. In some implementations, the virtual network interface controller vNIC1 may be configured to generate or process a communication request or a communication packet based on TCP/IP protocols. However, the present disclosure is not limited thereto, and the virtual network interface controller vNIC1 may operate based on various communication protocols.

Other virtual machines (e.g., VMa) among the plurality of virtual machines VM1 and VMa may have a similar structure to the above-described virtual machine VM1, and detailed explanation thereof will not be provided.

The container Cont1 may be various applications that are run on the operating system OS1 of the host 301. In some implementations, whereas each of the plurality of virtual machines VM1 and VMa executes an independent virtual operating system, the container Cont1 may be run on the operating system OS1 of the host 301 or may share the operating system OS1. In the remaining configurations except the configuration of the operating system, the container Cont1 may have a similar structure to the virtual machine VM1, and a detailed explanation thereof will not be provided. In some implementations, the number of virtual machines and the number of containers that are run on the host 301 may vary.

The switch SW1 may be configured to perform functions of mediating, switching, or routing various communication requests or communication packets. The switch SW1 may be a physical switch or a virtual switch. The switch SW1 may perform the functions of mediating, switching, or routing communications between various components included in the host 301 (e.g., virtual machines, containers) or communications between the hosts (e.g., hosts 301 and 302).

For example, the switch SW1 may be configured to receive communication requests from a plurality of virtual machines VM1 and VMa, or the container Cont1, and perform switching or routing on the received communication requests. As a more detailed example, when a communication packet for the virtual machine VMa included in the same host (e.g., the host 301) is generated from the virtual machine VM1, the switch SW1 may provide the communication request from the virtual machine VM1 to the virtual machine VMa. In some implementations, when a communication request for the virtual machine VM2 of the host 302 which is another host is issued from the virtual machine VM1, the switch SW1 may transfer the communication request from the virtual machine VM1 to the operating system OS1. The operating system OS1 may transfer the communication request from the switch SW1 to the host 302 through the network interface controller NIC1 and the network 400.

The network interface controller NIC1 may be configured to control communication between the host 301 and the host 302. The network interface controller NIC1 may be configured to generate or process communication requests or communication packets based on the TCP/IP protocol.

The heterogeneous computing interface controller CXL1 may be, but not limited to, an interface based on the CXL protocol. Depending on the implementation, the heterogeneous computing interface controller CXL1 may be implemented based on at least one of various computing interfaces, such as Gen-Z protocol, NVLink protocol, CCIX protocol, and Open CAPI protocol.

Because the CXL storage devices 60-a and 60-b include structures similar to the CXL storage devices 60-1 to 60-n explained with reference to FIGS. 1 to 20, a description of the configuration of the CXL storage devices 60-a and 60-b will not be provided.

The CXL storage device 60-a may communicate with the internal configurations of the host 301 (e.g., virtual machine VM1, etc.) through the heterogeneous computing interface controller CXL1. The CXL storage device 60-2 may communicate with the internal configurations of the host 302 (e.g., virtual machine VM2, etc.) through the heterogeneous computing interface controller CXL2.

Although FIG. 21 shows that the CXL storage device 60-a is disposed outside the host 301, the embodiment is not limited thereto. In some implementations, the CXL storage device 60-a may be included inside the host 301. Similarly, although FIG. 21 shows that the CXL storage device 60-b is disposed outside the host 302, the present disclosure is not limited thereto, and the CXL storage device 60-b may also be disposed inside the host 302.

The host 302 may include an operating system OS2, a plurality of virtual machines VM2 and VMb, a container Cont2, a switch SW2, a network interface controller NIC2, and a heterogeneous computing interface controller CXL2. The virtual machine VM2 may include a virtual central processing unit vCPU2, a virtual memory vMEM2, and a virtual network interface controller vNIC2. Because the components included in the host 302 have been explained through the components included in the host 301, a detailed explanation thereof will not be provided.

In some implementations, each of hosts 301 and 302 may be a physically spaced computing system (e.g., a server system). In some implementations, each of hosts 301 and 302 may refer to logically distinct systems inside the same computing system. That is, each of the hosts 301 and 302 may be divided based on the operating system that is run on each host (i.e., the host operating system). That is to say, each of the hosts 301 and 302 may be a system that runs the host operating systems independent of each other.

In some implementations, the host 301 and host 302 may communicate with each other through the network 400. For example, the host 301 may provide data to or receive data from the host 302 through the network 400. In some implementations, the network 400 may be a storage-only network, such as a storage area network (SAN) or an Internet network such as TCP/IP. In some implementations, the network 400 may include at least one of various communication protocols, such as Ethernet protocol, Fiber Channel, iSCSI protocol, FCoE, NAS, and NVMe-oF.

The memory expander 310 may communicate with the hosts 301 and 302 through a heterogeneous computing interface. In the following explanation, the communication interface between the hosts 301 and 302 and the memory expander 310 is assumed to be a CXL protocol-based interface.

In the following explanation, communication between various components is assumed to be performed in the form of sending and receiving packets. That is, communication between the virtual machines VM1 and VM2 may be performed by sending and receiving the communication packets or the packets including various types of information.

The memory expander 310 may include a controller 311 and a memory device 312. The controller 311 may receive packets from the hosts 301 and 302 through the CXL interface, and may control the memory device 312 based on the received packets. The memory device 312 may store the data or output the stored data according to the control of the controller 311. In some implementations, the memory device 312 may be a device based on a volatile memory, such as a DRAM and a SRAM, or a non-volatile memory, such as a NAND flash memory, a MRAM, a PRAM, and a ReRAM, or combinations thereof.

In some implementations, the memory expander 310 may be a memory corresponding to Type 3 defined by the CXL protocol standard. For example, the memory expander 310 may operate as a system memory or a host memory of the hosts 301 and 302 or a memory managed by the host through the CXL interface.

In some implementations, the memory device 312 of the memory expander 310 may include a virtual switch memory 312a and a virtual switch memory 312b. The virtual switch memory 312a may refer to a memory region that is used or managed by the switch SW1 of the host 301 or corresponds to the switch SW1. The virtual switch memory 312b may refer to a memory region that is used or managed by the switch SW2 of the host 302 or corresponds to the switch SW2.

Hereinafter, some implementations will be described based on communication between the virtual machine VM1 of the host 301 and the virtual machine VM2 of the host 302. However, the present disclosure is not limited thereto, and the technical idea of the present disclosure may be applied between the virtualized components of the host 301 and the virtualized components of the host 302.

The virtual machine VM1 and the virtual machine VM2 may communicate with each other through the CXL interface and the memory expander 310. For example, the virtual machine VM1 may transmit the data to the virtual machine VM2.

In this way, because the communication between the virtual machines VM1 and VM2 is performed through the CXL interface and the memory expander 310, the communication between the virtual machines VM1 and VM2 may be accelerated.

For example, the communication for transmitting the data from the virtual machine VM1 to the virtual machine VM2 may be performed. At this time, the data transmitted from the virtual machine VM1 to the virtual machine VM2 may be data managed by the virtual machine VM1. In some implementations, the virtual machine VM1 may transmit the caching data 85-a stored in the volatile memory 62-a to the virtual machine VM2 through the CXL interface and the memory expander 310, when an SPO occurs on the CXL storage device 60-a.

The virtual machine VM1 may generate a communication packet for transferring the caching data 85-a stored in the CXL storage device 60-a to the virtual machine VM2. In some implementations, the communication packet may be generated by the virtual network interface controller vNIC1 of the virtual machine VM1, and may have a format based on TCP/IP protocol.

The communication packet generated by the virtual machine VM1 may be transferred to the switch SW1. The switch SW1 may check a destination of communication packet based on the information (e.g., IP header) included in the communication packet. When the checked destination is the virtual machine VM2, the switch SW1 may generate a CXL communication packet based on the communication packet. In some implementations, the switch SW1 may generate a CXL communication packet, by adding a CXL header based on the CXL protocol to a part of the communication packet. The generated CXL communication packet may be transferred to the operating system OS1. The operating system OS1 may output the CXL communication packets through the heterogeneous computing interface controller CXL1.

The memory expander 310 may receive CXL communication packets that is output from the heterogeneous computing interface controller CXL1. The memory expander 310 may store the caching data included in the CXL communication packet in the virtual switch memory 312a in response to the CXL communication packet. After that, the memory expander 310 receives another CXL communication packet from the switch SW1, and may transfer the caching data stored in the virtual switch memory 312a to the virtual switch memory 312b in response to the another received CXL communication packet. In some implementations, transfer of caching data may be performed in a variety of ways, such as a physical copy to the caching data, an address reference, or a copy to a shared region.

The memory expander 310 may transfer the second CXL communication packet to the host 302 through the CXL interface after the transfer of the caching data is completed. In some implementations, the second CXL communication packet may be a packet including the caching data stored in the virtual switch memory 312b. In some implementations, the second CXL communication packet may be a communication packet that reports that caching data is stored in the virtual switch memory 312b. The operating system OS2 of the host 302 may receive the second CXL communication packet through the CXL interface controller CXL2, and transfer the received second CXL communication packet to the switch SW2. The switch SW2 may generate a TCP/IP communication packet based on the second CXL communication packet, and transfer it to the virtual machine VM2. The virtual machine VM2 may store the caching data in the virtual memory vMEM2 in response to the received TCP/IP communication packet. In some implementations, the virtual machine VM2 may check that the caching data is stored (or referenced) in the virtual switch memory 312b of the memory expander 310 in response to the received TCP/IP communication packet. In this case, the virtual machine VM2 may read the caching data stored (or referenced) in the virtual switch memory 312b through the heterogeneous computing interface controller CXL2.

In this way, an SPO occurs in the CXL storage device 60-a that communicates with the virtual machine VM1 through the heterogeneous computing interface controller CXL1, and when there is a need to maintain the caching data 85-a stored in the volatile memory 62-a of the CXL storage device 60-a, the virtual machine VM1 may move the caching data 85-a to the memory expander 310 outside the host 301. That is, when the SPO that occurs in the CXL storage device 60-a is an own problem inside the host 301, the virtual machine VM1 may move the caching data 85-a to the memory expander 310 or move it to another host 302 through the memory expander 310 to retain the caching data 85-a.

After that, when the CXL storage device 60-a is supplied with stable power again, or its own problems inside the host 301 is resolved, the virtual machine VM1 may access the caching data 85-a stored in the memory expander 310 again through the heterogeneous computing interface controller CXL1, or may access the caching data 85-a stored in the host 302 again through the heterogeneous computing interface controller CXL1 and the memory expander 310.

In some implementations, the communication between the virtual machine VM1 and the switch SW1 and the communication between the virtual machine VM2 and the switch SW2 may be performed through communication packets based on TCP/IP protocol, and the communication between the host 301 and the memory expander 310 and the communication between the host 302 and the memory expander 310 may be performed through communication packets based on the CXL protocol. As mentioned above, because the communication between the virtual machines VM1 and VM2 is performed through the heterogeneous computing interface (e.g., the CXL interface) and the memory expander 310 rather than the network 400, the communication speed between the virtual machines VM1 and VM2 can be improved.

In some implementations, the computing system 300 may further include the host 303. The host 303 may further include configurations (e.g., containers, switches, operating systems, etc.) included in the host 301 or the host 302, including the virtual machine VM3.

In some implementations, the host 301 and the host 303 may be connected only through the network 400. At this time, when the virtual machine VM1 of the host 301 communicates with the virtual machine VM3 of the host 303, the switch SW1 may not perform another processing on the communication packet from the virtual machine VM1 (i.e., generates a CXL communication packet based on the CXL protocol). In other words, the virtual machine VM1 and the virtual machine VM3 may communicate through the network 400.

In some implementations, the communication between the virtual machine VM1 and the virtual machine VM2 may be performed through the CXL interface and the memory expander 310, as described above. Accordingly, the communication between the virtual machines may be accelerated. In some implementations, the communication between the operating system OS1 and the operating system OS2, located at a lower layer than the virtual switch, may be performed through the memory expander 310 or the network 400.

Although a case where an SPO occurs in the CXL storage device 60-a has been explained as an example above, it is a matter of course that, even if an SPO occurs in the CXL storage device 60-b, the virtual machine VM2 may move the caching data 85-b to the memory expander 310 or may move it to the host 301 through the memory expander 310.

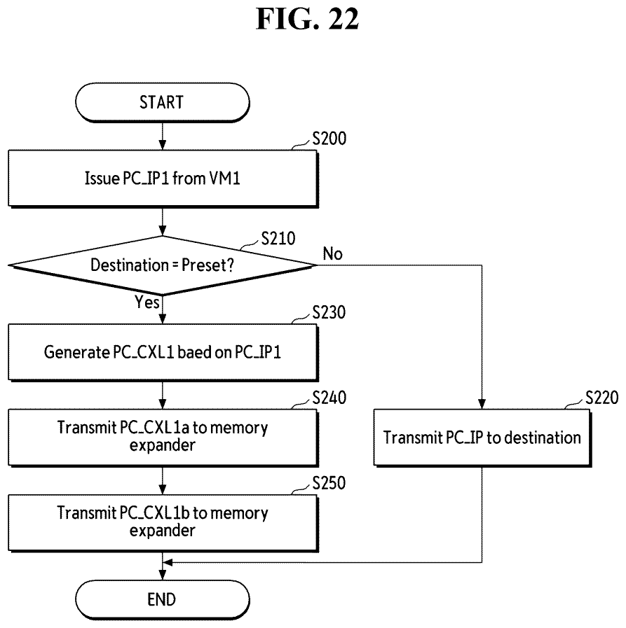

FIG. 22 is a flowchart showing an example of an operation of the host 301 of FIG. 21 according to some implementations. Implementations will be described below based on a configuration in which the virtual machine VM1 manages the caching data 85-a and the virtual machine VM1 transmits the caching data 85-a to the virtual machine VM2. However, the scope of the present disclosure is not limited thereto, and the technical idea of the present disclosure may be applied to various communications between the virtualized components.

In FIGS. 21 and 22, at step S200, the host 301 may generate a first IP communication packet PC_IP1. For example, the virtual machine VM1 of the host 301 may issue a first IP communication packet PC_IP1 for transmitting the caching data 85-a to the virtual machine VM2. The first IP communication packet PC_IP1 may include caching data 85-a. The first IP communication packet PC_IP1 may be a communication packet based on TCP/IP protocol.

At step S210, the host 301 may discriminate whether the destination or target of the first IP communication packet PC_IP1 is a preset virtual machine (e.g., virtual machine VM2). For example, the switch SW1 may check the destination of the first IP communication packet PC_IP1 based on the header (e.g., Ethernet header, IP header, TCP header, etc.) of the first IP communication packet PC_IP1. The switch SW1 may compare the checked destination with information of a preset virtual machine. In some implementations, a preset virtual machine may be a virtual machine (or other virtualized component) that runs a host operating system different from the first IP communication packet PC_IP1 source (e.g., virtual machine VM1), and is included in a host (e.g., host 302) connected to the memory expander 310a through the CXL interface.

When the destination of the first IP communication packet PC_IP1 is not a preset virtual machine, the host 301 may transfer the first IP communication packet PC_IP1 to the destination at step S220. In some implementations, the operation of step S220 may be performed by routing of the switch SW1 inside the host 301 or may be performed through the network 400. For example, if the destination of the first IP communication packet PC_IP1 is another virtual machine or container included in the host 301, the switch SW1 may transfer the first IP communication packet PC_IP1 to another virtual machine or container included in the host 301. In some implementations, if the destination of the first IP communication packet PC_IP1 is a virtual machine or a container of another host (e.g., the host 303 that is not connected to the memory expander 310), the host 301 may transmit the first IP communication packet PC_IP1 to the network 400 through the network interface controller NIC1, and the first IP communication packet PC_IP1 may be provided to a destination through the network 400.

When the destination of the first IP communication packet PC_IP1 is a preset virtual machine, the host 301 may generate the first CXL communication packet PC_CXL1 on the basis the first IP communication packet PC_IP1 at step S230. For example, the switch SW1 may generate the first CXL communication packet PC_CXL1, by adding a CXL header based on the CXL protocol to a part of the first IP communication packet PC_IP1.

At step S240, the host 301 may transmit a first-a CXL communication packet PC_CXL1a to the memory expander 310. For example, the operating system OS1 of the host 301 may receive the first-a CXL communication packet PC_CXL1a from the switch SW1, and may transmit the received first-a CXL communication packet PC_CXL1a to the memory expander 310 through the heterogeneous computing interface controller CXL1.

At step S250, the host 301 may transmit the first-b CXL communication packet PC_CXL1b to the memory expander 310. For example, the operating system OS1 of the host 301 may receive a first-b CXL communication packet PC_CXL1 from the switch SW1, and may transmit the received first-b CXL communication packet PC_CXL1b to the memory expander 310 through the heterogeneous computing interface controller CXL1. In some implementations, the first-a CXL communication packet PC_CXL1a may be a communication packet for storing the caching data 85-a in the virtual switch memory 312a, and the first-b CXL communication packet PC_CXL1b may be a communication packet for copying/referencing/sharing the caching data 85-a from the virtual switch memory 312a to the virtual switch memory 312b. As explained above, the host 301 or the switch SW1 of the host 301 may change the format of the first IP communication packet PC_IP1 based on the destination of the first IP communication packet PC_IP1 generated from the virtual machine VM1, or may hook the IP communication packet PC_IP and transfer it to the memory expander 310.

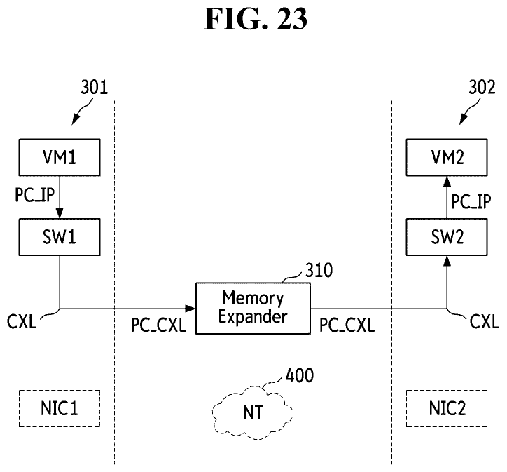

FIG. 23 is a diagram showing an example of an operation of transmitting the data from the virtual machine VM1 to the virtual machine VM2 in the computing system of FIG. 21 according to some implementations. In FIGS. 21 and 23, the virtual machine VM1 of the host 301 may generate an IP communication packet PC_IP based on the TCP/IP protocol. The switch SW1 of the host 301 may generate a CXL communication packet PC_CXL based on the IP communication packet PC_IP from the virtual machine VM1, and may transmit the CXL communication packet PC_CXL to the memory expander 310 through the CXL interface. The memory expander 310 may perform an operation corresponding to the CXL communication packet PC_CXL from the host 301, generate the CXL communication packet PC_CXL, and may transmit the CXL communication packet PC_CXL to the host 302 through the CXL interface. The switch SW2 may generate the IP communication packet PC_IP based on the CXL communication packet PC_CXL, and transmit the IP communication packet PC_IP to the virtual machine VM2.

In FIG. 23, in the layer of the virtual machines VM1 and VM2 of the host 301, a communication based on the TCP/IP protocol may be performed, similarly to the existing communication way. On the other hand, a physical communication between the hosts 301 and 302 may be performed by the communication based on the CXL protocol instead of using the network interface controllers NIC1 and NIC2 and the network 400. Accordingly, the communication between the virtual machines VM1 and VM2 may be accelerated.

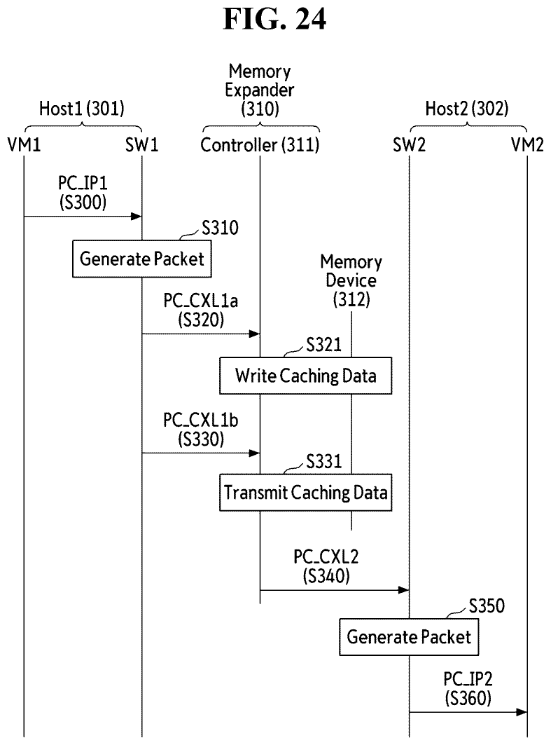

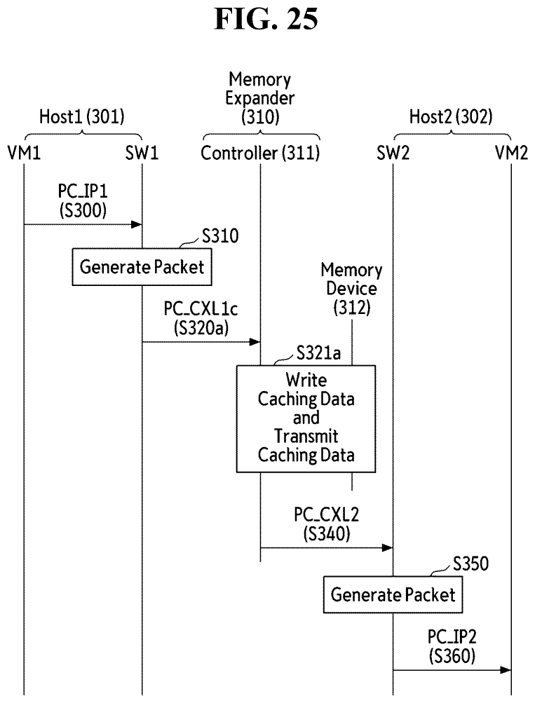

FIGS. 24 and 25 are flowcharts showing examples of an operation of the computing system of FIG. 21 according to some implementations. As mentioned above, for convenience of explanation, the operation of transmitting the caching data 85-a from the virtual machine VM1 to the virtual machine VM2 will be described. In some implementations, the caching data transmission operations according to the flowcharts of FIGS. 24 and 25 may be performed in response to an explicit request for the caching data 85-a of the virtual machine VM2. In this case, the caching data request from the virtual machine VM2 may be sent and received through the CXL interface and the memory expander 310. In some implementations, request for the caching data may be sent and received through the network 400, and transmission of the caching data 85-a may be performed through the CXL interface and the memory expander 310. In some implementations, the caching data transmission operation according to the flowchart of FIG. 24 or 25 may be initiated in response to the operations and requests of other virtual machines.

In FIGS. 21 and 24, at step S300, the virtual machine VM1 may issue the first IP communication packet PC_IP1. The first IP communication packet PC_IP1 may be a communication packet for providing the caching data 85-a to the virtual machine VM2. The first IP communication packet PC_IP1 may have a packet structure based on the TCP/IP protocol. The first IP communication packet PC_IP1 may include caching data 85-a stored in the CXL storage device 60-a.

At step S310, the switch SW1 may generate the first CXL communication packet PC_CXL1 based on the first IP communication packet PC_IP1. For example, the switch SW1 may generate the first CXL communication packet PC_CXL1 by adding a CXL header based on the CXL protocol to apart of the first IP communication packet PC_IP1. In an exemplary embodiment, the number of first IP communication packets PC_IP1 and the number of first CXL communication packets PC_CXL1 may vary depending on the size or operating mode of the caching data 85-a.

At step S320, a first-a CXL communication packet PC_CXL1a may be provided to the controller 311 of the memory expander 310. For example, the switch SW1 may provide the first-a CXL communication packet PC_CXL1a to the operating system OS1. The operating system OS1 may transmit the first-a CXL communication packet PC_CXL1a to the memory expander 310 through the heterogeneous computing interface controller CXL1. In some implementations, the switch SW1 may be directly connected to the heterogeneous computing interface controller CXL1 through the CXL interface, and the switch SW1 may directly transmit the first CXL communication packet PC_CXL1-a to the memory expander 310. In an exemplary embodiment, the first-a CXL communication packet PC_CXL1a may include caching data 85-a.

At step S321, the controller 311 of the memory expander 310 may store the caching data 85-a in response to the first-a CXL communication packet PC_CXL1a. For example, the controller 311 may store the caching data 85-a in a corresponding memory region (e.g., virtual switch memory 312a) based on the CXL header of the first-a CXL communication packet PC_CXL1a.

At step S330, a first-b CXL communication packet PC_CXL1b may be provided to the controller 311 of the memory expander 310. The first-b CXL communication packet PC_CXL1b may be provided in the manner similar to the first-a CXL communication packet PC_CXL1a of step S320, and detailed explanation thereof will not be provided. In some implementations, the first-b CXL communication packet PC_CXL1b may be a request for transferring the caching data 85-a from the virtual switch memory 312a to the virtual switch memory 312b.

At step S331, the controller 311 of the memory expander 310 may transfer the caching data 85-a stored in the virtual switch memory 312a to the virtual switch memory 312b in response to the first-b CXL communication packet PC_CXL1b. In some implementations, the transfer of the caching data 85-a may be performed based on various ways, such as a copying operation, a referencing operation or a sharing operation, which will be described in more detail with reference to the following drawings.

After the transfer of the caching data 85-a is completed, at step S340, the memory expander 310 may transmit the second CXL communication packet PC_CXL2 to the host 302 through the CXL interface. In some implementations, the second CXL communication packet PC_CXL2 may include caching data 85-a. In some implementations, the second CXL communication packet PC_CXL2 may include information reporting that the caching data 85-a is prepared in the virtual switch memory 312b.

At step S350, the switch SW2 may generate the second IP communication packet PC_IP2 based on the second CXL communication packet PC_CXL2. For example, the switch SW2 may generate the second IP communication packet PC_IP2, by adding an Ethernet header to some information of the second CXL communication packet PC_CXL2.

At step S360, the switch SW2 may provide the second IP communication packet PC_IP2 to the virtual machine VM2.

In some implementations, the second IP communication packet PC_IP2 may have a packet structure based on the TCP/IP protocol. The virtual network interface controller vNIC2 of the virtual machine VM2 may de-packetize the second IP communication packet PC_IP2 to identify the caching data 85-a or recognize that the caching data 85-a is stored in the virtual switch memory 312b of the memory expander 310. In some implementations, the virtual machine VM2 may read the caching data 85-a through a read operation on the memory expander 310. In this case, the read operation may be performed through communication based on the CXL protocol.

Next, in FIGS. 21 and 25, the virtual machine VM1 and the switch SW1 may perform the operations of step S300 and step S310, and the controller 311 of the memory expander 310, the switch SW2 of the host 302, and the virtual Machine VM2 may perform the operations of steps S340 to S360. Since this is similar to that explained with reference to FIG. 24, detailed explanation thereof will not be provided.

After step S310, the switch SW1 may provide a first-c CXL communication packet PC_CXL1c to the controller 311 of the memory expander 310 at step S320a. At step S321a, the controller 311 of the memory expander 310 may perform an operation of storing the caching data 85-a in the virtual switch memory 312a, and transferring the caching data 85-a from the virtual switch memory 312a to the virtual switch memory 312b. In the exemplary embodiment, the storage and transfer operations of the caching data may be performed by one CXL communication packet. The storage and transfer operations of the caching data may be performed in an atomic operation.

In some implementations, the first-c CXL communication packet PC_CXL1c may have a structure similar to an M2S Request with Data (RwD) message defined by the CXL protocol. That is, the first-cCXL communication packet PC_CXL1c may include caching data 85-a, and at least a part of the CXL header may include information about the distribution of the caching data.

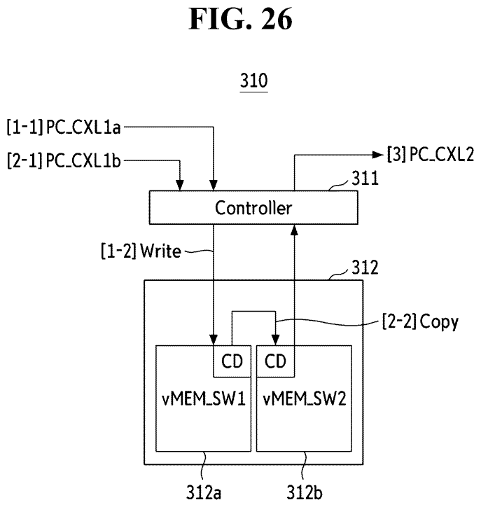

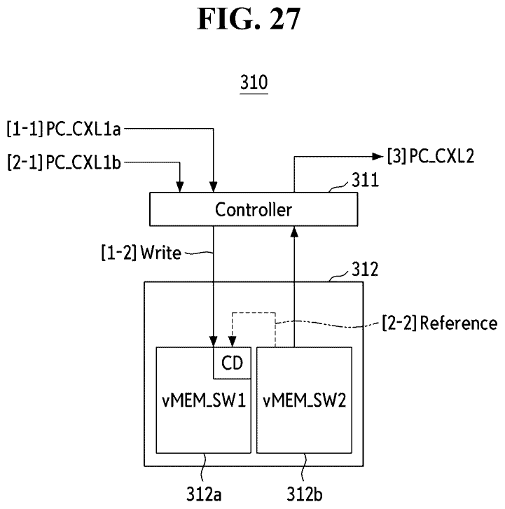

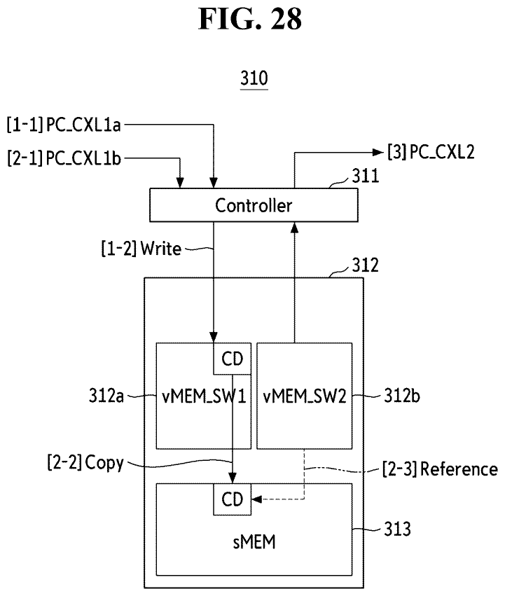

FIGS. 26 to 28 are diagrams showing examples of data transfer of the memory expander of FIG. 21 according to some implementations. An example of a copying operation of the caching data CD will be explained with reference to FIG. 26, an example of a referencing operation of the caching data CD will be explained with reference to FIG. 27, and an example of a sharing operation of the caching data CD will be explained with reference to FIG. 28. The caching data CD shown in FIGS. 26 to 28 may be the caching data 85-a of FIG. 21.

Although the transfer operation of the caching data CD will be described below based on the operation of the memory expander 310, the present disclosure is not limited thereto, and the controller 311 of the memory expander 310 may control the memory device 312 so that the transfer operation of the caching data is performed.

First, referring to FIGS. 21 and 26, [1-1] the memory expander 310 may receive the first-a CXL communication packet PC_CXL1a. [1-2] The memory expander 310 may store the caching data CD in the virtual switch memory 312a in response to the first-a CXL communication packet PC_CXL1a.

[2-1] The memory expander 310 may receive the first-b CXL communication packet PC_CXL1b. [2-2] The memory expander 310 may copy the caching data CD stored in the virtual switch memory 312a to the virtual switch memory 312b in response to the first-b CXL communication packet PC_CXL1b.

After that, [3] the memory expander 310 may transmit the second CXL communication packet PC_CXL2 including the caching data CD stored in the virtual switch memory 312b to the host 302 or the virtual machine (VM2).

In some implementations, the caching data storage operations of [1-1] and [1-2] and the transfer operations of [2-1] and [2-2] may be performed through one communication packet. Since this has been explained with reference to FIG. 25, detailed explanation thereof will not be provided.

Next, referring to FIGS. 21 and 27, the memory expander 310 may perform operations of [1-1] and [1-2]. Since this is similar to that described above, detailed explanation thereof will not be provided. [2-1] The memory expander 310 may receive the first-b CXL communication packet PC_CXL1b. [2-2] The memory expander 310 may perform the referencing operation on the caching data CD stored in the virtual switch memory 312a in response to the first-b CXL communication packet PC_CXL1b.

In some implementations, the referencing operation may refer to an operation performed in a manner of referencing an address at which the caching data CD is stored without a physical copying operation on the caching data CD. The referencing operation may be performed based on mapping information between the stored data and the address at which the data is stored. For example, after the referencing operation on the caching data CD is performed, a read operation on the caching data CD may be performed by reading the caching data CD stored in the virtual switch memory 312a through the controller 311 based on the mapping information.

After that, [3] The memory expander 310 may transmit a second CXL communication packet PC_CXL2 including the caching data CD stored in the virtual switch memory 312b to the host 302 or the virtual machine VM2.

In some implementations, at the time of the referencing operation, after a reference time has elapsed after the time at which the caching data CD stored in the virtual switch memory 312a is referenced, a copying operation of copying the caching data CD from the virtual switch memory 312a to the virtual switch memory 312b may be performed.

Next, in FIGS. 21 and 28, the memory expander 310 may perform operations of [1-1] and [1-2]. Since this is similar to that described above, detailed explanation thereof will not be provided. [2-1] The memory expander 310 may receive the first-b CXL communication packet PC_CXL1b. The memory expander 310 may perform the sharing operation on the caching data CD stored in the virtual switch memory 312a in response to the first-b CXL communication packet PC_CXL1b.

In some implementations, the sharing operation may refer to a transfer operation of caching data CD using the shared memory 313 included in the memory expander 310. For example, the memory device 312 of the memory expander 310 may include the virtual switch memories 312a and 312b and the shared memory 313. The shared memory 313 may refer to a memory region shared for data transfer between the virtual switch memories 312a and 312b.

[2-2] The memory expander 310 may copy the caching data CD stored in the virtual switch memory 312a to the shared memory 313 in response to the first-b CXL communication packet PC_CXL1b. After that, [2-3] The memory expander 310 may perform a referencing operation on the caching data CD stored in the shared memory 313. Because the referencing operation is similar to that explained with reference to FIG. 27, except that the position at which the caching data CD is stored is the shared memory 313, detailed explanation thereof will not be provided.

In some implementations, instead of referencing the caching data CD stored in shared memory 313, at the time of the sharing operation, the copying operation of copying the caching data CD from the shared memory 313 to the virtual switch memory 312b may be performed.

In some implementations, at the time of the sharing operation, after a reference time has elapsed from the time at which the caching data CD stored in the shared memory 313 is referenced, the copying operation of copying the caching data CD from the shared memory 313 to the virtual switch memory 312b may be performed. As mentioned above, the transfer operation of the caching data CD performed inside the memory expander 310 may be performed based on various ways.

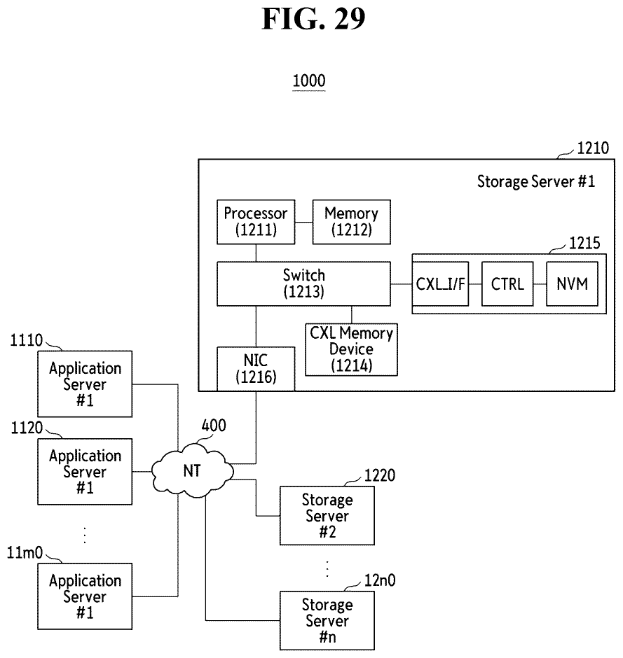

FIG. 29 is a diagram showing an example of a data center in which a computing system is applied according to some implementations. In FIG. 29, the data center 1000 is facility that collects various types of data and provide a service, and may be referred to as a data storage center. For example, the data center may be a system for search engine and database operation, and may be a computing system used by a company such as a bank or a government agency. The data center 1000 may include application servers 1110 to 11m0 and storage servers 1210 to 12n0. The number of application servers and the number of storage servers may be variously selected according to a particular implementation, and the number of application servers may be different from the number of storage servers.

Hereinafter, the configuration of the first storage server 1210 will be mainly explained. Each of the application servers 1110 to 11m0 and the storage servers 1210 to 12n0 may have a similar structure, and the application servers 1110 to 11m0 and the storage servers 1210 to 12n0 may communicate with each other through the network 400.

The first storage server 1210 may include a processor 1211, a memory 1212, a switch 1213, a CXL storage device 1215, a CXL memory device 1214, and a network interface controller (NIC) 1216. The processor 1211 may control the overall operation of first storage server 1210, and may access the memory 1212 to execute instructions loaded into the memory 1212 or process the data. The memory 1212 may be a DDR SDRAM (Double Data Rate Synchronous DRAM), a HBM (High Bandwidth Memory), a HMC (Hybrid Memory Cube), a DIMM (Dual In-line Memory Module), an Optane DIMM or a NVMDIMM (Non-Volatile DIMM). The processor 1211 and the memory 1212 may be directly connected, and the number of processors 1211 and the number of memories 1212 included in one storage server 1210 may be selected variously.

In some implementations, the processor 1211 and the memory 1212 may provide a processor-memory pair. In some implementations, the number of processors 1211 and memories 1212 may differ from each other. The processor 1211 may include a single-core processor or a multi-core processor. The above description of the storage server 1210 may be similarly applied to each of application servers 1110 to 11m0.

The switch 1213 may be configured to mediate or route communications between various components included in the first storage server 1210. In some implementations, the switch 1213 may be a CXL switch 51 described in FIGS. 1 to 15. That is, the switch 1213 may be a switch implemented based on the CXL protocol.

The CXL memory device 1214 may be connected to the switch 1213. In some implementations, the CXL memory device 1214 may be used as a memory expander for the processor 1211. In some implementations, the CXL memory device 1214 may be allocated as a dedicated memory or a buffer memory for the CXL storage device 1215, as explained with reference to FIGS. 10 to 20.

The CXL storage device 1215 may include a CXL interface circuit CXL_IF, a controller CTRL, and a non-volatile memory NVM. The CXL storage device 1215 may store data or output stored data at the request of the processor 1211. In some implementations, the CXL storage device 1215 may be the CXL storage device explained with reference to FIGS. 2 to 28. In some implementations, the CXL storage device 1215 may be allocated with at least a partial region of the CXL memory device 1214 as a dedicated region, and may use the dedicated region as a buffer memory (i.e., the meta data is stored in the CXL memory device 1214), similarly to that explained with reference to FIGS. 10 to 20.

According to some implementations, the application servers 1110 to 11m0 may not include the CXL storage devices 1215. The storage server 1210 may include at least one or more CXL storage devices 1215. The number of CXL storage devices 1215 included in the storage server 1210 may be variously selected depending on the implementation.

The network interface controller (NIC) 1216 may be connected to the switch 1213. The NIC 1216 may communicate with other storage servers 1220 to 12n0 or other application servers 1110 to 11m0 through the network 400.

In some implementations, the NIC 1216 may include a network interface card, a network adapter, or the like. The NIC 1216 may be connected to the network 400 by a wired interface, a wireless interface, a Bluetooth interface, an optical interface, or the like. The NIC 1216 may include an internal memory, a DSP (Digital Signal Processor), a host bus interface, and the like, and may be connected to the processor 1211 and/or the switch 1213 and the like through the host bus interface. In some implementations, the NIC 1216 may be integrated with at least one of the processor 1211, the switch 1213, and the CXL storage device 1215.

In some implementations, the network 400 may be implemented using Fiber Channel (FC), Ethernet, or the like. At this time, the FC may be a medium used for relatively high-speed data transmission, and an optical switch that provides high performance/high availability may be used. Depending on the access way of the network 400, the storage servers may be provided as a file storage, a block storage or an object storage.

In some implementations, the network 400 may be a storage-only network such as a SAN (Storage Area Network). For example, the SAN may be a FC-SAN that utilizes an FC network and is implemented according to FCP (FC protocol). As another example, the SAN may be an IP-SAN that utilizes TCP/IP network and is implemented according to an iSCSI (SCSI over TCP/IP or Internet SCSI) protocol. In some implementations, the network 400 may be a general network such as a TCP/IP network. For example, the network 400 may be implemented according to protocols such as an FCoE (FC over Ethernet), a NAS (Network Attached Storage), and a NVMe-oF (NVMe over Fabrics).

In some implementations, at least one of the application servers 1110 to 11m0 may store data requested to store by a user or client in one of the storage servers 1210 to 12n0 through the network 400. At least one of the application servers 1110 to 11m0 may obtain data requested to read by a user or client from one of the storage servers 1210 to 12n0 through the network 400. For example, at least one of the application servers 1110 to 11m0 may be implemented as a web server, a database management system (DBMS), or the like.

In some implementations, at least one of the application servers 1110 to 11m0 may access the memory, the CXL memory device or the CXL storage device included in other application servers through the network 400, or may access the memories, the CXL memory devices or the CXL storage devices included in the storage servers 1210 to 12n0 through the network 400. Accordingly, at least one of the application servers 1110 to 11m0 may perform various operations on data stored in other application servers and/or storage servers. For example, at least one of the application servers 1110 to 11m0 may execute instructions for moving or copying the data between other application servers and/or storage servers. At this time, data may be moved from the storage device of the storage server via the memories or the CXL memory devices of the storage server, or may be directly moved to the memories or CXL memory device of the application servers. Data that moves through the network may be encrypted data for security or privacy.

In some implementations, the storage device included in at least one of the application servers 1110 to 11m0 and the storage servers 1210 to 12n0 may be allocated with the CXL memory device included in at least one of the application servers 1110 to 11m0 and the storage servers 1210 to 12n0 as a dedicated region, and the storage device may use the allocated dedicated region as a buffer memory (i.e., store the meta data). For example, the CXL storage device 1215 included in the storage server 1210 may be allocated with the CXL memory device included in another storage server (e.g., 12n0), and may access the CXL memory device included in another storage server (e.g., 12n0) through the switch 1213 and the NIC 1216. In this case, the meta data on the CXL storage device 1215 of the first storage server 1210 may be stored in the CXL memory device of the other storage server 12n0. That is, the storage devices and the CXL memory devices of the data center according to the present disclosure may be connected and implemented in a variety of ways.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

1. A computing system comprising:
a storage cluster that includes one or more storage devices; and
a switch providing an interface between the storage devices in the storage cluster,
wherein the storage devices of the storage cluster include a first storage device and a second storage device,
wherein the first storage device includes:
a first storage controller;
a first non-volatile memory configured to be controlled by the first storage controller; and
a first volatile memory that includes a first memory region and a second memory region,
wherein the first storage device is configured to provide first data stored in the first memory region to the second storage device through the switch, based on power not being supplied at the first storage device, and
wherein the first data is caching data.

2. The computing system of claim 1,
wherein the first storage device further includes:
a Power Loss Protection (PLP) circuit; and
a PLP battery connected to the PLP circuit,
wherein the PLP circuit is configured to flush second data stored in the second memory region to the first non-volatile memory using the PLP battery, based on the power not being supplied at the first storage device.

3. The computing system of claim 2, further comprising:
a host connected to the storage cluster through the switch,
wherein the host is configured to transmit a request associated with user data to the first storage device through the switch, and
wherein the second memory region is configured to store mapping data of the user data.

4. The computing system of claim 1, further comprising:
a host connected to the storage cluster through the switch,
wherein the host includes:
a host processor configured to communicate with the first storage controller;
a baseboard management controller (BMC); and
an auxiliary power supply.

5. The computing system of claim 4,
wherein the first storage device further includes a microcontroller that communicates with the BMC, and
wherein, the auxiliary power supply is configured to, based on the power not being supplied at the first storage device, supply auxiliary power to the microcontroller.

6. The computing system of claim 5, wherein the BMC is configured to, based on the power not being supplied at the first storage device, communicate with the microcontroller to monitor a status of the first storage device.

7. The computing system of claim 5, wherein the first storage controller is configured to, based on the microcontroller being supplied with the auxiliary power from the auxiliary power supply, provide the first data to the second storage device through the switch.

8. The computing system of claim 1, further comprising:
a memory device connected to the storage cluster through the switch,
wherein the memory device includes a memory controller,
wherein the memory controller is configured to, based on the power not being supplied at the first storage device, receive a request corresponding to the first data from the first storage device, and
wherein the memory controller is configured to, based on receiving the request, generate information indicative of transmitting the first data to the second storage device.

9. The computing system of claim 8,
wherein the memory controller is configured to provide the information to the first storage controller through the switch, and
wherein the first storage controller is configured to provide the first data to the second storage device through the switch in response to receiving the information.

10. The computing system of claim 1,
wherein the interface is a Compute Express Link (CXL) interface,
wherein the computing system further comprises a normal storage cluster including one or more normal storage device, and
wherein the normal storage devices in the normal storage cluster are connected to an interface different from the CXL interface.

11. A computing system comprising:
a host;
a storage cluster that includes one or more storage device;
a memory device that includes a memory controller; and
a switch providing an interface between the host, the storage device included in the storage cluster, and the memory device,
wherein the storage devices of the storage cluster include a first storage device and a second storage device,
wherein the first storage device includes:
a first storage controller;
a first non-volatile memory configured to be controlled by the first storage controller; and
a first volatile memory configured to store first data and second data,
wherein the first storage controller is configured to transmit a request corresponding to the first data to the memory controller through the switch, based on power not being supplied at the first storage device,
wherein the memory controller is configured to generate information indicative of transmitting the first data to the second storage device in response to receiving the request,
wherein the memory controller is configured to provide the information to the first storage controller through the switch,
wherein the first storage controller is configured to provide the first data to the second storage device through the switch in response to receiving the information, and
wherein the first data is caching data for the host to access the storage cluster.

12. The computing system of claim 11,
wherein the memory controller is configured to generate information indicative of transmitting the first data to the second storage device, based on telemetry information of storage devices included in the storage cluster, and
wherein the memory controller is configured to periodically update the telemetry information from the storage devices included in the storage cluster through the switch.

13. The computing system of claim 12, wherein the telemetry information includes at least one of an execution status, a capacity, an input/output (I/O) bandwidth, a storage processor usage, or a data buffer usage of each of the storage devices included in the storage cluster.

14. The computing system of claim 11,
wherein the host is configured to transmit a request associated with user data to the first storage device through the switch, and
wherein the second data includes mapping data of user data.

15. The computing system of claim 11,
wherein the first storage device further includes:
a Power Loss Protection (PLP) circuit; and
a PLP battery connected to the PLP circuit,
wherein the PLP circuit is configured to flush the second data stored in the first volatile memory to the first non-volatile memory using the PLP battery based on the power not being supplied at the first storage device.

16. A method for operating a computing system which includes a host, a storage cluster including a first storage device and a second storage device, a memory device, and a switch, the method comprising:
transmitting a request to the memory device through the switch, by a first storage controller included in the first storage device, based on power not being supplied at the first storage device;
receiving the request from the first storage controller through the switch, by a memory controller included in the memory device;
generating, by the memory controller, information indicative of transmitting first data corresponding to at least some of data stored in the first storage device to the second storage device based on the request;
providing, by the memory controller, the information to the first storage controller through the switch; and
providing, in response to receiving the information, the first data to the second storage device through the switch by the first storage controller,
wherein the first data is caching data for the host to access the storage cluster.

17. The method for operating the computing system of claim 16,
wherein the first storage device includes:
a first non-volatile memory configured to be controlled by the first storage controller; and
a first volatile memory configured to store the first data,
wherein the first volatile memory includes a first memory region configured to store the first data, and a second memory region configured to store second data different from the first data.

18. The method for operating the computing system of claim 17,
wherein the first storage device further includes:
a Power Loss Protection (PLP) circuit; and
a PLP battery connected to the PLP circuit, and
wherein the method further comprising flushing the second data to the first non-volatile memory by the PLP circuit, using the PLP battery based on the power not being supplied at the first storage device.

19. The method for operating the computing system of claim 16,
wherein the host includes:
a baseboard management controller (BMC); and
an auxiliary power supply,
wherein the first storage device further includes a microcontroller configured to communicate with the BMC, and
wherein the auxiliary power supply is configured to supply auxiliary power to the microcontroller based on the power not being supplied at the first storage device.

20. The method for operating the computing system of claim 19, wherein the providing of the first data to the second storage device by the first storage controller through the switch includes providing the first data to the second storage device by the first storage controller through the switch, in response to the microcontroller being supplied with the auxiliary power from the auxiliary power supply.
